(19) United States
(12) Patent Application Publication
(10) Pub. No.: US 2021/0031250 A1
(43) Pub. Date: Feb. 4, 2021

(54) Non-polluting Biomass Waste Processor, Components and Processes for Use by a Municipality, Industrial, Forestry and/or Agricultural Facility

(71) Applicant: Magnum Group International, Inc., Reno, NV (US)

(72) Inventors: Serge Borys, Burnaby (CA); Uladzimir Kalitko, Minsk (BE)

(21) Appl. No.: 16/966,524

(22) PCT Filed: Jan. 21, 2019
(86) PCT No.: PCT/US2019/015312

§ 371 Date: Jul. 31, 2020

Related U.S. Application Data
(60) Provisional application No. 62/626,001, filed on Feb. 3, 2018.
(60) Provisional application No. 62/755,940, filed on Nov. 5, 2018.
(60) Provisional application No. 62/199,136, filed on Jul. 30, 2015.

(51) Int. Cl. B09B 3/00; C02F 11/10; F23G 5/027; F23G 7/00; F23G 7/10; B09C 1/06

(52) U.S. Cl. CPC B09B 3/0091; C02F 11/10; F23G 5/027; F23G 2209/12; F23G 7/10; B09C 1/065; F23G 7/001

(57) ABSTRACT

Implementations of a non-polluting biomass processor, and manufactured processor components are disclosed which at least partly address the local technical problems of a municipality, business, and/or organization, to generate non-polluting emissions, while generating at least one, often two or more, product outputs from biomass feedstocks input into the biomass processor. Examples of the operations of the biomass processor and various combinations of its manufactured processor components are disclosed. The product outputs may include carbon char and/or activated carbon, both of which may be used to increase water retention in climates with hot, dry summers and/or used to remediate water pollution in water reservoirs.

### TECHNICAL FIELD

This patent application discloses a non-polluting biomass waste processor. This processor produces outputs, which at least partly, locally address the production, supply and waste treatment problems of a municipality, locality, an industrial and/or agricultural facility. The disclosed apparatus includes the biomass processor and/or components of the biomass processor, as well as the process of operating the biomass processor and its configuration, to at least partly solve the above problems.

### BACKGROUND

Today, most municipalities and industries in North America and the rest of the world, generate biomass waste products that cannot be economically converted into useful products without producing toxic pollutants. While this in itself is a problem, the document also discloses other related problems.

### SUMMARY

The inventors and applicant began work in the area of municipal solid waste treatment several years ago. They realized that several seemingly unrelated technical problems were actually closely related. They also realized that there was an integrated systematic solution to these seemingly separate problems that their biomass processor 1000 solves. The technical problems 1030 focus into four arenas: supply, product, waste treatment and management problems. Solving these problems lead to multiple implementations of the biomass processor first shown in FIG. 1, and subsequently developed throughout this document.

For example, municipalities may face one or more supply problems 1032 as shown in FIG. 2A that frequently need to be addressed to solve the production problems 1034 shown in FIG. 2B: Biomass waste composition 1710 may vary dramatically from one location to another. Biomass waste availability tends to change throughout the year, which leads to the technical problem of local biomass seasonal variation 1712. In terms of daily operation of waste treatment facilities, most biomass waste is delivered in truckloads. This can lead to a local biomass daily variation 1714. Solving the supply problems is frequently necessary to solve the production problems for a municipality.

The production problems 1034 may include, but are not limited to the one or more of the following as shown in FIG. 2B: providing fuel for a vehicle 1700, electricity to at least one facility 1702, providing purification of water pollution 1704 and/or providing purification of air pollution 1706. These unsolved technical production problems require payment by most municipalities from their tax collections and/or charges from their community users. These community users are frequently the elderly, the infirm and the young, who are limited in their economic resources. Those most in need are often required to pay the highest fraction of their resources.

Essentially all municipalities are responsible for treating the wastes produced within their jurisdiction. There are several persistent waste treatment problems 1036 as shown in FIG. 2C. A municipality and/or industry and/or business may need to solve one or more of these technical problems: a landfill problem 1720, a sewage sludge problem 1722, an incineration problem 1724, a rubber and/or plastic waste problem 1726, and a petroleum waste problem 1728.

The management problems 1038 may include, but are not limited to, one or more of the following as shown in FIG. 2D as a plant cost of installation 1730, a plant component availability cost 1734, and a plant unit size 1736

A non-polluting biomass processor 1000 produces outputs at least partly addressing production, supply and waste treatment problems of a municipality from its biomass waste. The disclosed apparatus includes the biomass processor and/or manufactured components of the biomass processor, which together form manufactured apparatus adapted and configured to provide various embodiments. These manufactured components address the plant cost problems by bringing the efficiency of mass production to these manufactured embodiments. Rather than building one-of-a kind implementations, the various modules are used wherever they are needed. The users of these embodiments are not investing in custom facilities. Rather, these facilities enjoy a substantial cost savings brought about by the volume of components across all of these embodiments, thereby bring savings to all who invest in them.

The non-polluting biomass processor may be adapted to generate atmospheric emissions containing essentially no dioxin. The biomass processor adds essentially no ash to its atmospheric emissions. The biomass processor responds to input water by generating wastewater. If the input water does not have pollutants such as heavy metals, the processor may use the input water as its clean water. If the input water has pollutants such as heavy metals, certain embodiments of the processor include a water filter using the activated carbon 1070 generated by the processor to remove those pollutants to create clean water used in the processor. In either case, the processor does not add heavy metals to the wastewater. As a consequence, the biomass processor will be referred to herein as a non-polluting biomass processor.

The non-polluting biomass processor and/or components of the biomass processor are configured to process the biomass wastes of the municipality to create one or more fuel outputs and/or activated carbon with essentially no pollution. The non-polluting biomass processor may be adapted to produce at least two fuel outputs for municipal use, which may include one or more of the following:
The non-polluting biomass processor generates syngas and bio-oil.
The non-polluting biomass processor may be adapted to respond to the receipt of municipal biomass waste and/or industrial biomass waste to generate activated carbon for municipal use.

The apparatus may further include at least one of a biomass input processor 1000, a furnace 1100, an activated carbon reactor 1400, a thermal assembly 1200, a boiler 1300, a oil-gas separator 1600, and/or a dust separator 1500. The manufactured processor components 1050 of the biomass processor 1000 may include one or more of the furnace 1100, the activated carbon reactor 1400, the thermal assembly 1200, the boiler 1300, the oil-gas separator 1600, and/or the dust separator 1500. There are several ways in which one or more of the apparatus may interact:
Each of these elements may be adapted to operate with, or in, the non-polluting biomass processor 1000.
As used herein, a first entity is adapted to operate with a second entity will refer to a tangible relationship between the first and second entity. For example, the first entity may be couple by one of its outlets to an inlet of the second entity.
The first entity may further be adapted to operate within the second entity may refer to the first entity being included in the second entity and adapted to operate in the second entity.
Each of these elements may be configured to operate with, or in, the non-polluting biomass processor 1000.
As used herein, a first entity configured to operate with a second entity will refer to a process by which the first entity interacts with second entity. For example, the first entity may respond to the temperature of the second entity by consuming more or less fuel.
Similarly, a first entity configured to operate in a second entity will refer to a process by which the first entity interacts with second entity and the second entity includes the first entity.

The apparatus may include at least one of the following:
The biomass input processor 1000 adapted to respond to receiving at least one biomass waste to generate a biomass feedstock 1010 of a specific particle size range and a specific humidity range. [symbol]
A furnace 1100 adapted to operate at a first temperature 1110 in response to receiving a first syngas 1080 and air to heat and generate a flue-gas at a second temperature.
A thermal assembly 1200 adapted to separately receive the flue-gas exiting from the furnace 1100 at the second temperature, the biomass feedstock 1010, and a steam at about boiling point to generate the flue-gas at a third temperature, a carbon char, a pyrogas and a second steam at a second temperature range.
An activated carbon reactor 1400 adapted to be heated by the furnace 1100 and to operate at or near the first temperature 1110 to receive the carbon char 1072 to generate an activated carbon 1070 and a second syngas 1442.
A boiler 1300 adapted to be heated by the third temperature flue-gas exiting the thermal assembly 1200 and to receive clean water to generate the steam at the first temperature 1232 range for the thermal assembly. In some embodiments, the boiler 1300 may be adapted and operated for the further purpose of any combination of supplying pressure for spraying water, maintaining a consistent temperature in the oil-gas separator 1600, and supplying steam for the activated carbon reactor 1400.
The dust separator 1500 may be adapted to receive the pyrogas generated by the thermal assembly and separates the pyrogas into large dust particulates and a finer pyrogas without said large dust particulates.
The oil-gas separator 1600 may be adapted to receive steam from the boiler 1300 to spray water to create a stream of water droplets and to maintain a temperature of about the boiling point of water. The oil-gas separator 1600 receives the finer pyrogas from the dust separator 1500 and a jet stream of water droplets. The oil-gas separator 1600 responds by separating bio-oil, including fine dust particulates from the finer pyrogas, and also creates a clean syngas 1080. The clean syngas 1080 may be adapted to fuel the furnace 1100.

The thermal assembly 1200 may include a thermal assembly containing a first reactor 1920 and at least a last reactor 1990. The thermal assembly includes a flue-gas inlet and outlet, a feed stock inlet adapted to deliver the feedstock to the first reactor 1910, and the last reactor 1990 adapted to receive a result from the first reactor 1910, and a carbon char 1072 outlet. Various embodiments of the thermal assembly 1200 may include a steam heating apparatus to generate super-heated steam and/or a super-heated steam inlet adapted to receive the super-

[symbol]

The oil-gas separator 1600 may include a thermal jacket about an oil-gas condenser. The thermal jacket may be adapted to receive steam at about the boiling point from the boiler 1300 to heat the thermal jacket to about the boiling point of water to maintain that temperature throughout the oil-gas condenser. The oil-gas condenser may be adapted to receive the finer pyrogas from the dust separator 1500, a jet stream of water droplets and an internally generated steam jet. The oil-gas condenser separates bio-oil, including fine dust particulates from the finer pyrogas, and also creates the clean syngas 1080 including a third steam. The jet stream may be generated by an external jet stream generator and/or by an internal jet stream generator included in the oil-gas separator 1600.

The furnace 1100 and the activated carbon reactor 1400 may support the activated carbon reactor 1400 being directly heated by the furnace 1100 in any of several ways, including but not limited to, the activated carbon reactor 1400 being conductively coupled to the furnace 1100, the furnace 1100 containing the activated carbon reactor 1400 and the activated carbon reactor 1400 receiving thermal exhaust from the furnace 1100 to at least partially heat the activated carbon reactor 1400.

### BRIEF DESCRIPTION OF THE DRAWINGS

FIG. 1 shows an example of a non-polluting biomass processor 1000 responding to biomass feedstock 1010 and a processor configuration 1020 to generate non-polluting atmospheric emissions, non-polluting water emissions, as well as at least one of a bio-oil, a fuel oil, an activated carbon, a carbon char, a syngas, and a pyrogas as product outputs. The biomass processor, manufactured processor components, processor configuration, and at least one product output at least partly address at least one technical problem 1030.

FIG. 2A to FIG. 2D show examples of the local technical problems 1030 of FIG. 1.

FIG. 3A to FIG. 3C show some details of the relationship between the biomass feedstock and the non-polluting biomass processor of FIG. 1. FIG. 3D shows a refinement of FIG. 1 and FIG. 3A, which may include a gaseous scrubber adapted to receive raw atmospheric emissions from the biomass processor and configured to generate at least part of the non-polluting atmospheric emissions.

FIG. 4A to 4C show some examples of the uses of the activated carbon and/or the carbon char.

FIG. 5A to 5G show some introductory details of some the manufactured components 1050 of the non-polluting biomass processor 1000 of FIG. 1 in accord with solving at least some the technical problems 1030 shown in FIG. 2A to FIG. 2D and operable within at least one embodiment of the non-polluting biomass processor 1000.

FIG. 6A to FIG. 6C show simplified block diagrams of alternative implementations of the furnace 1100 of FIG. 5A and the activated carbon reactor 1400 of FIG. 5D as details of alternative implementations of the non-polluting biomass processor 1000 of FIG. 1.

FIG. 7A to FIG. 7E show examples of the non-polluting biomass processor 1000 using various combinations of the manufactured processor components 1050.

FIG. 8A to FIG. 8E show simplified block diagrams of some alternative implementation details of the thermal assembly 1200 and of the non-polluting biomass processor 1000.

FIG. 8F to FIG. 8I show the operation of the first hopper valve 2 of FIG. 8E to create an input cycle for biomass feedstock 1010 into the thermal assembly 1200.

FIG. 8J to FIG. 8M show the operation of the second hopper valve 2 of FIG. 8E to create an output cycle for the carbon char 1072 from the thermal assembly 1200.

FIG. 9A to FIG. 9G show some details relevant to at least some implementations of the thermal assembly 1200.

FIG. 10A and FIG. 10B show some details relevant to at least some of the implementations of the oil-gas separator 1600.

FIG. 11 shows some details relevant to the coupling one or more instances of the oil-gas separator 1600 coupled with one or more dust separators 1500.

FIG. 12 shows some details relevant to the activated carbon reactor 1400 adapted as a component either inside an implementation of the furnace 1100, and/or surrounded by the furnace 1100.

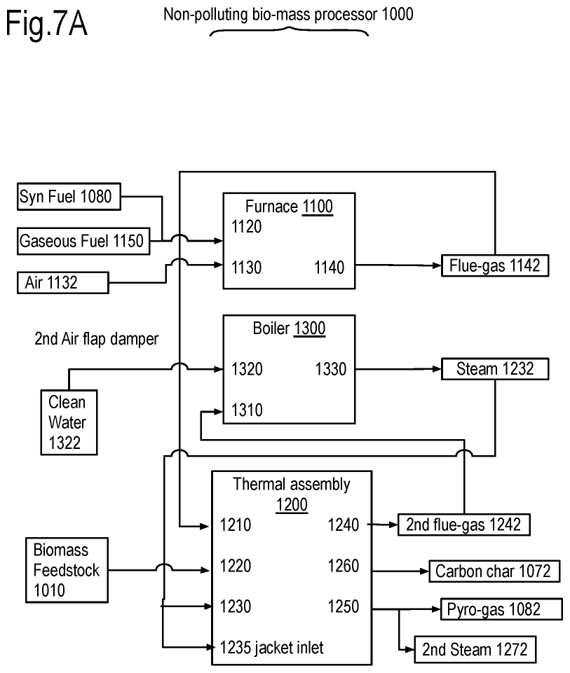

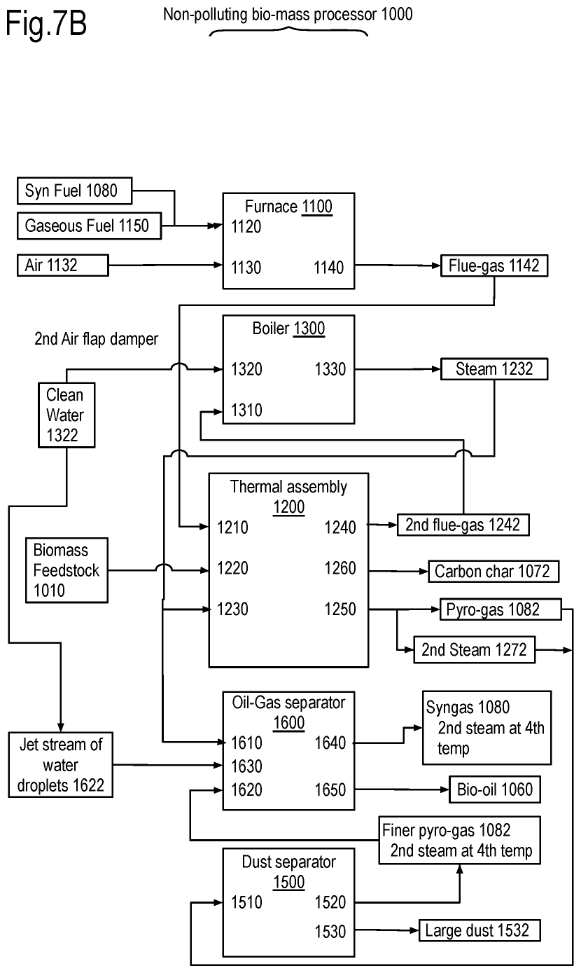

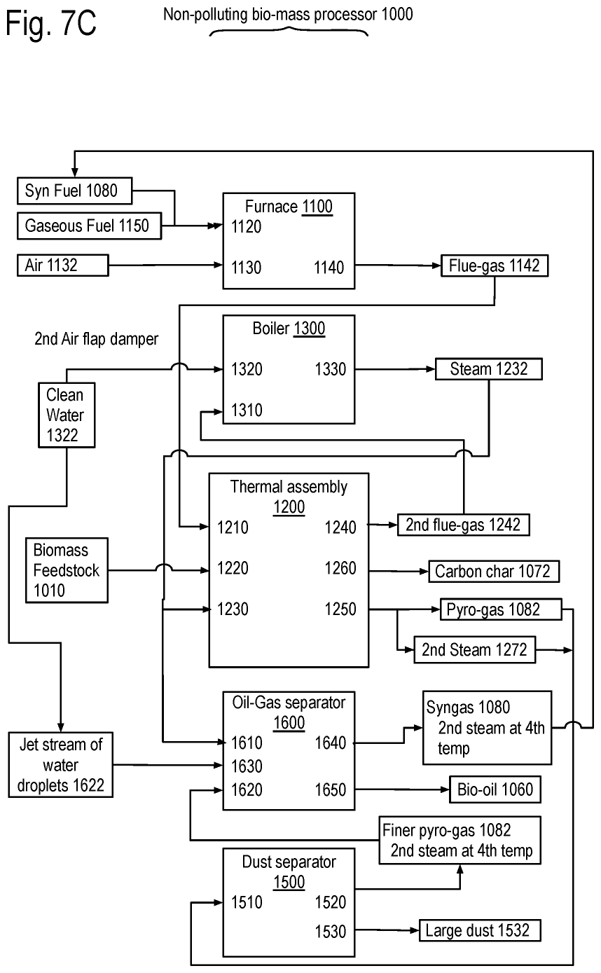

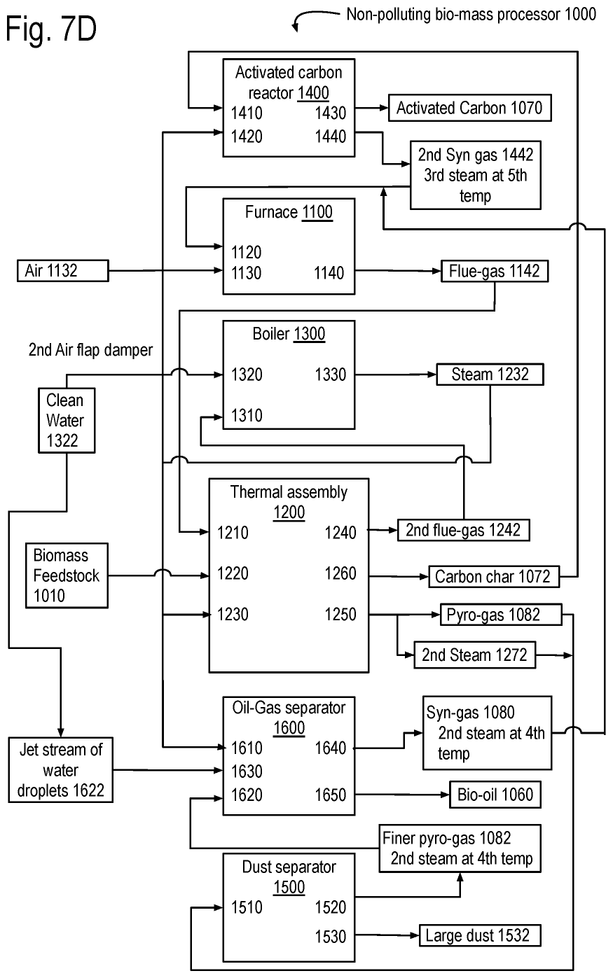

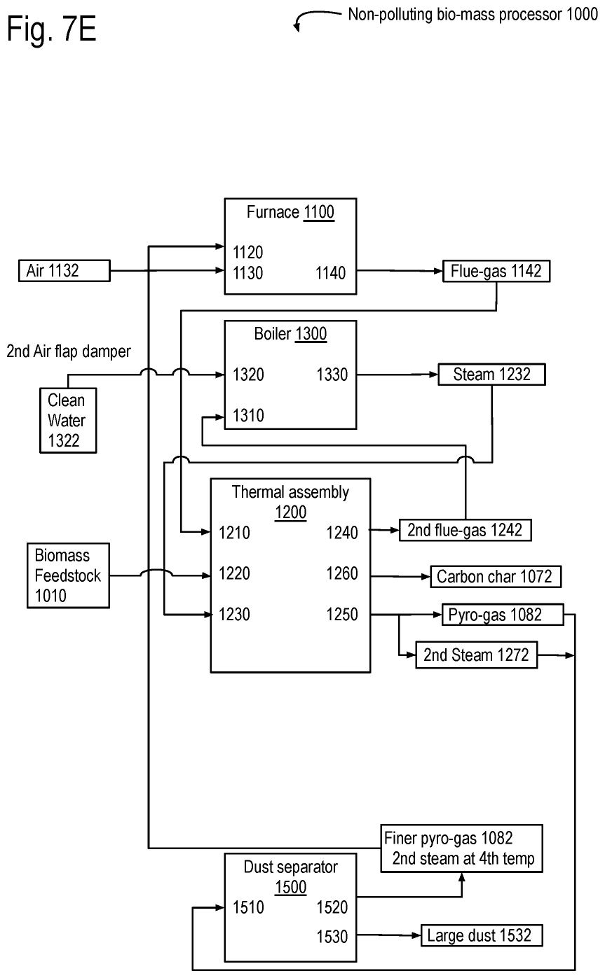

And FIG. 13 shows some details of the non-polluting biomass processor 1000 of FIG. 7D.

### DETAILED DESCRIPTION OF THE DRAWINGS

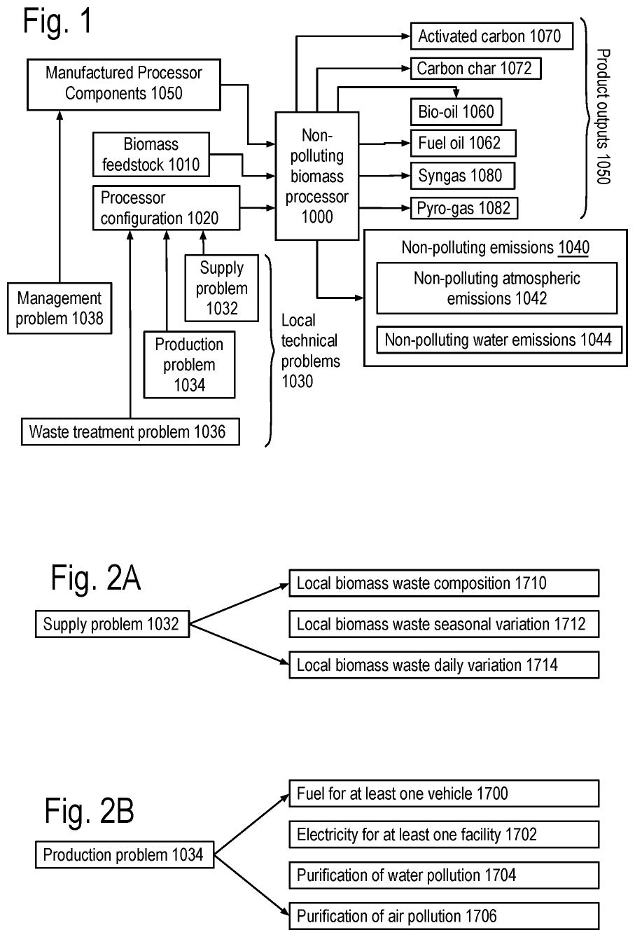

Often in developing a patent application, a summary of terms used in a disclosure is placed at the beginning of this section. However, to better serve the reader, a list of terms is placed after the description of FIG. 1, because this affords the reader some point of reference, before going into the details of the non-polluting biomass processor 1000 and the manufactured processor components 1050.

FIG. 1 shows an example of a non-polluting biomass processor 1000 responding to biomass feedstock 1010 and a processor configuration 1020 to generate non-polluting atmospheric emissions 1040, non-polluting water emissions 1050, at least one of a bio-oil 1060, a fuel oil 1062, an activated carbon 1070, a carbon char 1072, a syngas 1080, and a pyrogas 1082. Implementations of the non-polluting biomass processor 1000 each generate non- polluting atmospheric emissions 1040 and non-polluting water emissions 1050. Consider two examples of the non-polluting biomass processor 1000: A first non-polluting biomass processor 1000 generates activated carbon 1070, but no fuel oil 1062. A second non-polluting biomass processor 1000 generates fuel oil 1062, but no activated carbon 1070.

The processor configuration 1020 is generated based upon the non-polluting biomass processor 1000 at least partly addressing at least one production problem 1032, at least one supply problem 1034, at least one waste treatment problem 1036 and/or at least one management problem 1038. The manufactured processor components 1050 feed the installation and maintenance of the biomass processor 1000 to address at least one management problem 1038. The biomass processor 1000, its manufactured components 1050, the processor configuration 1020 are adapted and configured to at least partly address the local technical problems 1030 faced by the users of the biomass processor. 1500. The manufactured processor components 1050 of the biomass processor 1000 may include one or more of the furnace 1100, the activated carbon reactor 1400, the thermal assembly 1200, the boiler 1300, the oil-gas separator 1600, and/or the dust separator 1500.

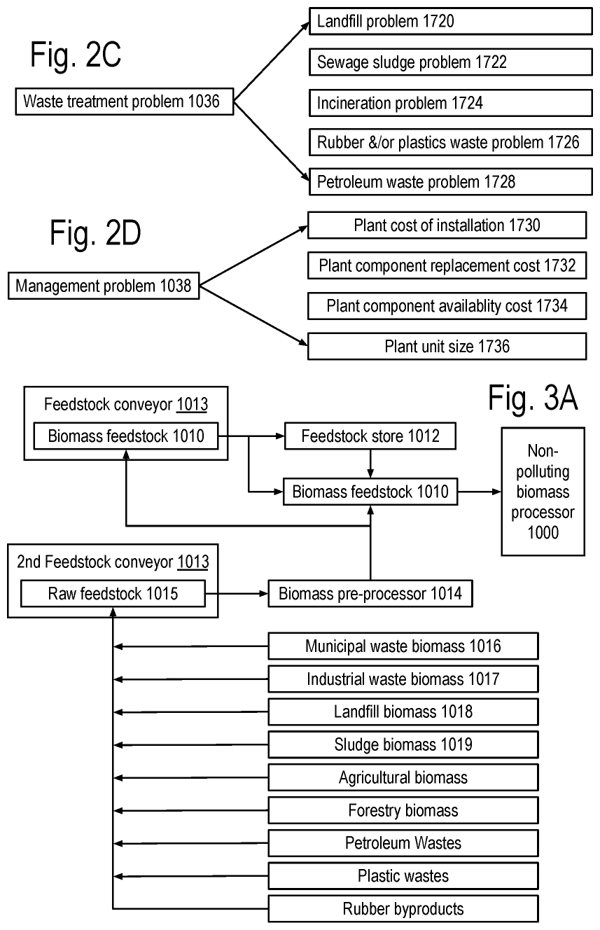

The local technical problems 1030 of FIG. 1 include, but are not limited to, at least one production problem 1032, at least one supply problem 1034, at least one waste treatment problem 1036 and/or at least one management problem 1038. FIG. 2A to FIG. 2D show examples of these local technical problems 1030, which are explained in greater detail in the summary above.

There are a number of terms through which the technical problems and their solution by the non-polluting biomass processor 1000, as well as side effects of the operation of the biomass processor. A number of these terms are defined for use herein:

A municipality may refer to any of the following, a village, town, township, suburb, rural district, neighborhood, city, county, utility district, regional administration, province, state, lake or river administration, a watershed administrative district, a region, nation, and/or

[symbol]

The term biomass refers to any organic matter that is available on a renewable or recurring basis, including municipal wastes, agricultural crops and trees, wood and wood wastes and residues, plants (including aquatic plants), grasses, residues, fibers, animal and fowl wastes, and other organic waste materials such sewage sludge capable of being thermodynamically processed to produce one or more of the following products: carbon char, activated carbon 1070, bio oil, syngas 1080 or energy. Biomass can be converted to bio-oil 1060 by the way of pyrolysis, liquefaction and gasification processes, which can also be further processed to obtain high-quality products with the help of upgrading and separation processes.

Bio-oil 1060 or Pyrolysis oil (sometimes described as biocrude) is a liquid fuel made from widely distributed biomass materials such as agricultural crops, animal wastes, algal biomass, municipal wastes, and agricultural and forestry by-products via thermo-chemical processes. Bio-oil 1060 contains a high level of oxygen and as such is not considered a hydrocarbon. As a new, clean and green bio-energy source, bio-oil 1060 is considered an attractive option to that of conventional hydrocarbon fuels in reducing environmental pollution.

A hydrocarbon refers to one or more organic compounds, consisting of hydrogen and carbon.

Syngas 1080 is a mixture of gas comprising approximately 85% of carbon monoxide and hydrogen, together with small amounts of methane, carbon dioxide other volatile organic compounds generated by the gasification of a carbon containing material having a heating value of which has an energy density less than one half of that of natural gas. The syngas 1080 so produced may contain some trace elements of impurities, which are removed from the syngas 1080 so that it can be used as a fuel in an integrated gasification combine cycle power generation configuration.

Pyrogas 1082 is a gas produced from the process of recovery of recyclable materials in an oxygen-free thermal decomposition environment, known as pyrolysis, in which a gas called pyrogas containing pyro-oil is produced by thermal decomposition of biomass waste comprising macromolecule organic compounds including rubber and plastics. The ratio and the chemical composition of the pyrogas 1082 depends on the type of feedstock materials sourced as well as the operational conditions of the pyrolysis process such as length of processing time, temperature, pressure and as in the described use of steam as a carrier of the pyro gas.

Flue-gas 1142 and 1242 refers to the gas exiting to the atmosphere via a flue, which tends to be a pipe or channel adapted to convey exhaust gases from a furnace 1100, fireplace, [symbol] what feedstock is being consumed. The distinct reference numbers refer to two versions of the flue-gas that may differ in temperature and/or pressure.

Carbon char 1072 is a material produced by incomplete combustion of biomass and/or heavy petroleum products. Carbon char 1072 refers to substances in the combustion products ranging from slightly charred degradable biomass to highly condensed refractory soot.

Activated carbon 1070 is a solid form of carbon processed to have small-to-volume pores that increase the surface area available for absorption or chemical reaction due to its high degree of microporosity. By way of example, 1 gram of activated carbon 1070 may have a surface area of not less than 500 square meters (m²) as determined by gas adsorption. The width of the pores may range from 0.3 to several thousand nanometers (nm). Activated carbon 1070 has an activation level sufficient for useful application, which may be obtained through its high surface area. In some embodiments, further chemical treatment may further enhance its adsorption properties.

Pyrolysis refers to a thermochemical decomposition of organic material at elevated temperatures without the participation of oxygen. It involves the simultaneous change of chemical composition and physical phase, and is irreversible.

The Venturi effect is the reduction in fluid pressure that results when a fluid flows through a constricted section of pipe.

The Venturi effect is a jet effect; as with a funnel the velocity of the fluid increases as the cross-sectional area decreases, with the static pressure correspondingly decreasing. According to fluid dynamics, a fluid's velocity must increase as it passes through a constriction to satisfy the principle of continuity, while its pressure must decrease to satisfy the principle of conservation of mechanical energy. Any gain in kinetic energy a fluid may accrue due to its increased velocity through a constriction is negated by a drop in pressure.

A Venturi tube operates as follows: Fluid flows through a length of pipe of varying diameter. To avoid undue drag, a Venturi tube typically has an entry cone of 30 degrees and an exit cone of 5 degrees. To account for the assumption of an inviscid fluid a coefficient of discharge is often introduced, which generally has a value of 0.98.

A venturi scrubber is designed to effectively use the energy from the inlet gas stream to atomize the liquid being used to scrub the gas stream. This type of technology is a part of the group of air pollution controls collectively referred to as wet scrubbers. It has been known for decades that the venturi configuration can be used to remove particles from gas streams, a process known as scrubbing. A venturi scrubber consists of three sections: a converging [symbol] section and, as the area decreases, gas velocity increases (in accordance with the Bernoulli equation). Liquid is introduced either at the throat or at the entrance to the converging section. The inlet gas, forced to move at extremely high velocities in the small throat section, shears the liquid from its walls, producing an enormous number of very tiny droplets. Particle and gas removal occur in the throat section as the inlet gas stream mixes with the fog of tiny liquid droplets. The inlet stream then exits through the diverging section, where it is forced to slow down. Venturis can be used to collect both particulate and gaseous pollutants, but they are more effective in removing particles than gaseous pollutants.

Current pyrolysis methods consist of two systems: pyrolysis in batch technologies and continuous pyrolysis technologies. For the pyrolysis in batch technologies, feedstock materials of various types such as organic biomass, used plastics and used tires are placed in a pyrolysis furnace, which is then heated to activate a pyrolyis reaction. Upon completion of the pyrolysis reaction, the furnace is cooled, depressurized and the pyro-products are removed. This prior art approach has the following disadvantages:
The pyrolysis furnace must be subjected to a repetitive heating and cooling cycle for each batch, which limits the production capacity of the process and is an inefficient use of the energy required.
That because of the loading and unloading it is difficult of make effective use of the pyrogases generated from the pyrolysis process.
During the unloading process a release of dust and pyrogases results which is a hazard to the environment.
Because of the above disadvantages the current preferred method of pyrolyzing feedstock is through the use of continuous pyrolysis methods. One of these methods is the continuous batch system which involves a series of reaction chambers connected together. The disadvantages of this system are:
Each reaction furnace has to be cooled and repeatedly heated.
Each reaction chamber must be unloaded and loaded repeatedly which incurs the disadvantages of a batch system referred to above.
The use of a series of reactors makes for a bulky plant configuration.
The individual operation of each furnace complicates the pyrolysis operation.
The second method is a continuous pyrolysis system which does not incorporate the plurality of parallel pyrolysis furnaces. This system is a dry pyrolysis method which uses a dry inert gas to carry the resultant pyrogas out. The disadvantages of this system are:
There is a danger of explosion in the furnace as a significant of combustible gases are generated during the high temperature process.
Sulfurous components in the feedstock materials will be released, leaving a high sulfur content in the pyrolysis by products produced, thereby lowering the quality and merchantability of the resultant by products.
There is not readily-available a cost effective inert gas in the pyrolysis industry having the capability of carrying the pyrogas out or a method of self-generating an inert gas having the capabilities required and it must be either specially produced or the supply of an inert gas has to be outsourced, thereby significantly increasing the operating costs of the system.

The local technical problems 1030 of FIG. 1 include one or more of the supply problem 1032 further detailed in FIG. 2A, the production problem 1034 further detailed in FIG. 2B, the waste treatment problem 1036, further detailed in FIG. 2C, and/or the management problem 1038 further detailed in FIG. 2D.

FIG. 2A shows some examples of a supply problem 1032 of FIG. 1 a municipality and/or local industry or business may need to solve. They may face at least one of the supply problems 1032, which frequently need to be addressed to solve the production problems 1034:
Biomass waste composition 1710 may vary dramatically from one location to another. Grassland territories have a different biomass waste composition 1710 than territories dominated by forests. Biomass wastes in agricultural neighborhoods reflect what is grown in that neighborhood. One county may produce grapes, another walnuts, a third, corn, and a fourth, rice. All of these counties potentially produce distinct biomass waste compositions 1710.
Biomass waste availability tends to change throughout the year, which leads to the technical problem of local biomass seasonal variation 1712. For instance, in the northern United States and most of Canada, availability of yard waste is near zero when there is a foot or more of snow on the ground. Leaf fall comes once a year and is concentrated in a very few weeks. Harvest of a crop also tends to be very focused.
In terms of daily operation of waste treatment facilities, most biomass waste is delivered in truckloads. Deliveries at 9:00 AM do not necessarily have the same proportion of various biomass wastes as deliveries at 4:00 PM. This can lead to a local biomass daily variation 1714. Solving the supply problems is frequently necessary to solve the production problems for a municipality.

FIG. 2B shows the production problem 1034 may include, but is not limited to, at least one of the following:
Most municipalities do not possess the resources and facilities to generate fuel for one or more vehicle, which may lead to a problem providing fuel for the vehicle 1700. As a consequence, most of these municipalities must spend part of their community taxes to pay for the fuel their public vehicles need. Further, most public transportation must charge community users to offset the cost of the fuel.
Most municipalities cannot locally and efficiently fuel electrical generators to power public facilities such as office buildings, schools, hospitals, senior centers, and day care centers. This fuel must be purchased, adding a significant ongoing expense to the operation of such facilities. This can lead to a problem providing electricity to at least one facility 1702. Today, most if not all, electrical generation systems that use biomass wastes are very large and expensive.
Most municipalities do not produce activated carbon. Activated carbon is the critical material for most filters that remove pollution from air or water. Municipalities face high prices to address air and water pollution problems and their effects. This can lead to a problem providing purification of water pollution 1704 and/or a problem providing purification of air pollution 1706.
At present, these unsolved technical production problems require payment by most municipalities from their tax collections and/or charges from their community users. These community users are frequently the elderly, the infirm and the young, who are limited in their economic resources. Those most in need are often required to pay the highest fraction of their resources.

FIG. 2C shows the waste treatment problem 1036 may include one or more of the following, which may need to be solved:
Landfills were abused in North America for decades. Now, environmental regulations on landfills have made them difficult and/or expensive to acquire, very constrained in operation, and a continuing liability once full. This can lead to a landfill problem 1720. Landfills are also a continuing source of greenhouse gases, in particular, methane and carbon dioxide, both of which are now taxed in both the US and Canada. There are international laws that now apply. These used up facilities are also likely to have new fees and regulations as time progresses. Municipalities lose in every one of these areas.
Sewage sludge left after sewage treatment must go somewhere and this is creating land and water pollution problems due to the presence of heavy metals and other pollutants found in the sludge. These components of the sludges often dissolve in the presence of water. The land containing, or covered by these sludges, becomes toxic, with these pollutants and water runoff contaminating rivers and streams fed by the runoff. These various situations can lead to one or more sewage sludge problems 1722.
Incineration is a commonly used waste treatment method, but one that comes with several negatives. Politically, no one wants a waste incinerator near their home. Incinerators are infamous for generating ash and air pollution, which frequently includes poisons, such as dioxin. These various situations can lead to one or more incineration problems 1724.
Many municipalities face rubber and/or plastics waste problems 1726, which may include, but is not limited to, one or more of the following situations: large amounts of broken tires, insulation, plastic containers, which may have accumulated into piles or landfills.
Many municipalities face one or more forms of a petroleum waste problem 1728. Examples of this problem can be found in many sites used for gas stations, fuel depots, storage facilities and chemical processing plants.
Recently, there has been a movement in many areas to outlaw the production of certain of these wastes, which may help stop or slow the severity of one or more of these problems. But municipalities cannot outlaw the existence of waste, they must deal with it into the foreseeable future.

FIG. 2D shows the management problem 1038 may include, but is not limited to, at least one of a plant cost of installation 1730, a plant component availability cost 1734, and a plant unit size 1736.
Most municipalities do not possess large amounts of money to invest in building expensive infrastructure components. Many businesses also do not possess the capital to invest in the building of expensive infrastructure components. Further, the plant cost of installation 1730 is often difficult to compute, and difficult to communicate among those responsible for the installation decision.
Most municipalities are hard hit by plant component replacement costs 1732, [symbol] to name just a few potential, frequently occurring causes. In disastrous situations, the plant component replacement may also involve an issue of plant component availability and its cost 1734, because many biomass processors are not mass produced, and their replacement components must often be ordered months in advance of their delivery date.
Many municipalities and/or industries struggle to determine a plant unit size 1736, because of the above management problems. The inventors have solved this plant unit size problem, by specifying and developing four plant intake capacities. Once the plant intake capacity has been determined, this determines the primary components of the biomass processor 1000 as manufactured processor components 1050. From the specified plant intake capacity, the other management problems can be addressed in a consistent and coherent fashion, which can be readily communicated and controlled by the relevant municipal and/or industrial organizations. By way of example, consider four intake capacities of 500, 1000, 2000 and 4000 Kg. A small municipality or small industrial facility may operate a single biomass processor 1000 of one of these capacities. However, a larger municipality or local collective of several sites may all operate the same size, and stockpile replacement components, to insure rapid recovery from emergencies at a reasonable overhead.

Typically, wastes of a municipality may be categorized as green, paper, plastics, and wood wastes, as well as glass, metal and rock wastes. The green wastes may in some situations be further delineated into yard wastes and/or food wastes. As used herein, biomass wastes essentially include the green, paper, plastics and/or wood wastes, where the inclusion of one or more of the glass, metal and/or rock wastes is less than 3 percent by volume, and usually less than 1 percent. In the US, municipal wastes typically have metal waste of 7-8%, glass waste of about 5%, paper waste of about 38%, plastic waste of about 12% plus the green waste of about 23-24%.

Industry, whether manufacturing, agriculture or forest related, also faces very similar biomass waste problems. Today, industry is forced to pay for waste removal as well the fuel, electrical energy, and pollution control for their industrial needs.

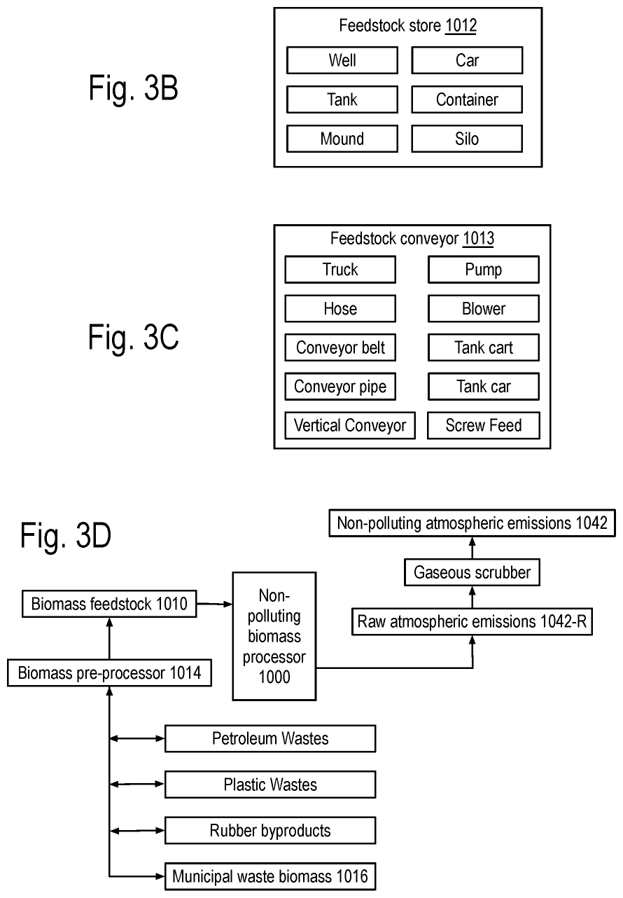

FIG. 3A to FIG. 3D show some details of the relationship between the biomass feedstock 1010 and the non-polluting biomass processor 1000 of FIG. 1.
FIG. 3A shows some details of the biomass feedstock 1010 being provided by some combination of a feedstock store 1012, a first feedstock conveyor 1013, and/or a biomass pre-processor 1014. The biomass pre-processor 1014 may be supplied a raw [symbol] include one or more of the following: a municipal waste biomass 1016, an industrial waste biomass 1017, a landfill biomass 1018, a sludge biomass 1019, an agricultural biomass, a forestry biomass, a petroleum biomass, a plastic waste and/or a rubber byproduct.
FIG. 3B shows some examples of the feedstock store 1012, including one or more of a well, a car, a tank, a container, a mound and/or a silo.
FIG. 3C shows some examples of the feedstock conveyer 1013, including one or more of a truck, a pump, a hose, a blower, a conveyor belt, a tank car, a vertical conveyor and a screw feed.
FIG. 3D shows a refinement of FIG. 1 and FIG. 3A where the biomass pre-processor 1014 may generate the biomass feedstock 1010 in response to the delivery of one or more of petroleum wastes, plastic wastes, rubber byproducts, and/or municipal waste products 1016. The biomass processor 1000 may respond to the delivered biomass feedstock 1010 by generating raw atmospheric emissions 1042-R. The raw atmospheric emissions 1042-R may be delivered to a gaseous scrubber to generate the non-polluting atmospheric emissions 1042 of FIG. 1.

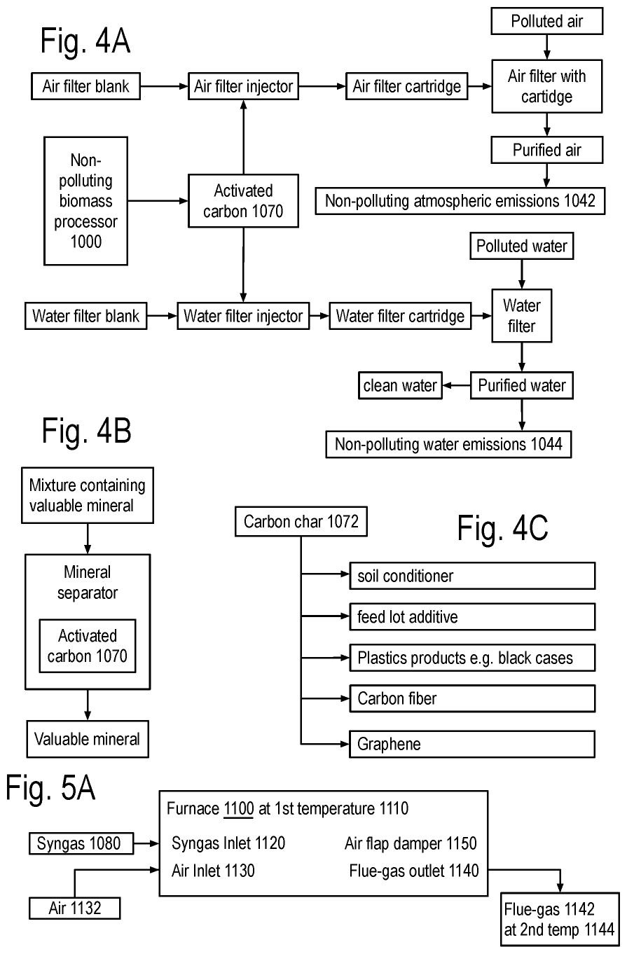

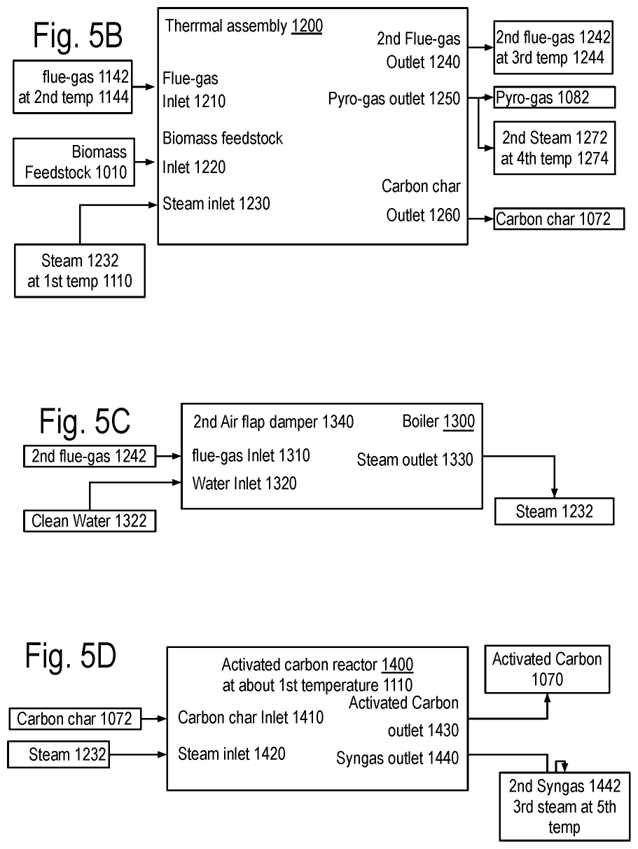

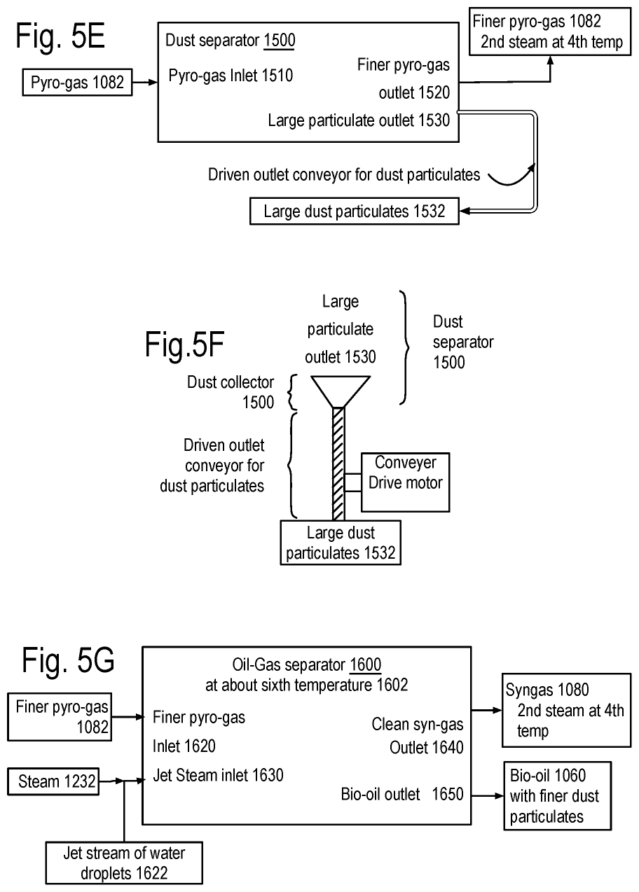

FIG. 4A to 4C show some examples of the uses of the activated carbon and/or the carbon char. FIG. 4A shows some refinements of the FIG. 1, where the non-polluting biomass processor 1000 may generate the activated carbon 1070. A particular implementation may implement one or more examples of the following:
An air filter injector may receive the activated carbon 1070, and an air filter blank, to create an air filter cartridge. An air filter, equipped with the air filter cartridge, may receive polluted air and generate purified air as at least part of the non-polluting atmospheric emissions 1042.
A water filter injector may receive the activated carbon 1070 and a water filter blank to create a water filter cartridge. A water filter including the water filter cartridge may receive polluted water to create purified water. The purified water may be at part of the non-polluting water emissions 1044 of FIG. 1. Also, the purified water may either be considered clean water 1322, safe for drinking, or may become clean water 1322 after one or more further water purification steps. The clean water may be further used in the non-polluting biomass processor 1000 and its manufactured components as first shown in FIG. 5C.

FIG. 4B shows an example use of the activated carbon 1070 of FIG. 1 in a mineral separator, which receives a mixture and/or suspension of a valuable mineral to create the

[symbol]

FIG. 4C shows some examples of the use of the carbon char 1072 of FIG. 1, including in a soil conditioner, in a feed lot additive, to create plastics products such as black cases, to create a carbon fiber, and/or to create graphene.

FIGS. 5A to 5G show some introductory details of some the manufactured processor components 1050 of the non-polluting biomass processor 1000 of FIG. 1 operable within at least one embodiment of the non-polluting biomass processor 1000. FIG. 5A introduces a furnace 1100. FIG. 5B introduces a thermal assembly 1200. FIG. 5C introduces a boiler 1300. FIG. 5D introduces an activated carbon reactor 1400. FIG. 5E introduces a dust separator 1500, with FIG. 5F showing some further details. And FIG. 5G introduces an oil-gas separator 1600.

FIG. 5A shows the furnace 1100 adapted to operate at about a first temperature 1110 in response to receiving the syngas 1080 through a syngas inlet 1120 possibly from the oil-gas separator 1600 and/or the activated carbon reactor 1400 and air 1132 from an air inlet 1130 to heat and generate a flue-gas 1142 at a second temperature 1144, which may heat the thermal assembly 1200. The furnace 1100 includes the syngas inlet 1120, the air inlet 1130, and a flue-gas outlet 1140. Combustion occurs between the syngas 1080 and the air to create the flue-gas 1142 leaving the furnace 1100 through the flue-gas outlet 1140 at a second temperature 1144.
By way of example, the first temperature 1110 may be in the range from 900° Centigrade (C) to 1100° C., which will be referred to as the first temperature 1110 range 1112. The second temperature 1144 may be in a second temperature range 1146 between 600° C. and 800° C.
In some situations, operating the furnace 1100 at the first temperature 1110 may act to decompose any environmental pollutants, such as dioxin, present in the syngas 1080 into harmless, simpler hydrocarbons in the flue-gas 1142.

FIG. 5B shows a thermal assembly 1200 adapted to separately receive the flue-gas 1142 at the second temperature 1144, the biomass feedstock 1010, and steam 1232 at a first temperature 1110 to generate a second flue-gas 1242 at a third temperature 1244, a pyrogas 1082, a carbon char 1072, and a second steam 1272 at a fourth temperature 1274, which is also referred to as super-heated steam 1272 herein. The thermal assembly 1200 includes a flue-gas inlet 1210, a biomass feedstock 1010 inlet 1220, a steam inlet 1230, a second flue-gas outlet 1240, a pyrogas outlet 1250, and a carbon char 1072 outlet 1260. The pyrogas outlet 1250 may output a mixture of the pyrogas 1082 and the second steam 1272 at the fourth temperature 1274, which is also referred to as the superheated steam 1272.
By way of example, the flue-gas 1142 and the second flue-gas 1242 may be of essentially the same chemical composition and may differ only in terms of their temperature and possibly their pressure.
Another example, the third temperature 1244 may be in a third temperature range 1246 between 400° C. and 600° C.
Another example, the fourth temperature 1274 may in a fourth temperature range 1276 between 350° C. and 450° C.

FIG. 5C shows a boiler 1300 adapted to receive the second flue-gas 1242 at the third temperature 1244 and clean water 1322 and generate the steam 1232 at the first temperature 1110 range. The boiler 1300 includes a flue-gas inlet 1310 adapted to receive the second flue-gas 1242, a water inlet 1320 adapted to receive the clean water 1232 and a steam outlet 1330 adapted to transfer the steam 1232 out of the boiler 1300 at a fifth temperature, and a flue-gas outlet 1310. By way of example, the boiler 1300 may operate by the second flue-gas 1242 heating the clean water 1322 to create the steam 1232 at about 150° C. at about four bars or atmospheres of pressure.

FIG. 5D shows an activated carbon reactor 1400 adapted to operate at or near the first temperature 1110 to receive a carbon char 1072, as well as the steam 1232 from the boiler 1300, and generates the activated carbon 1070 and a second form of syngas 1442 in response to the received carbon char 1072. The activated carbon reactor 1400 includes a carbon char inlet 1410 adapted to receive the carbon char 1072, a steam inlet 1420 adapted to receive the steam 1232 and an activated carbon outlet 1430 adapted to transfer the activated carbon 1070 out of the activated carbon reactor 1400, and a syngas outlet 1440 adapted to transfer the second form of the syngas 1442 out of the activated carbon reactor 1400.

FIG. 5E shows a dust separator 1500 adapted to receive the pyrogas 1082 generated by the thermal assembly 1200 through a pyrogas inlet 1510 and separates the pyrogas into large dust particulates 1532 leaving through a large dust particulate outlet 1530 as driven by a driven outlet conveyer for dust particles to collect the large dust particles 1532 and a finer pyrogas 1082 without the large dust particulates leaving through a finer pyrogas outlet 1520. The finer pyrogas 1082 is in mixture with a third form of steam at a fifth temperature.

FIG. 5F shows some details of FIG. 5E, where the large particulate outlet 1530 feeds large dust particulates 1532 through a driven output conveyor. The output conveyor is motivated by a conveyer drive motor to move the large dust particulates 1532 out of the dust separator, so that the dust separator 1500 does not clog at the large particulate outlet 1530.

FIG. 5G shows an oil-gas separator 1600, which may be adapted to receive steam 1232 from the boiler 1300 to maintain a sixth temperature 1602 of about the boiling point of water. The oil-gas separator 1600 includes a finer pyrogas inlet 1620 adapted to receive the finer pyrogas 1082, a jet stream inlet 1630 adapted to receive the steam 1232 and a jet steam of water droplets 1622, a clean syngas outlet 1640 adapted to output the syngas 1080, and a bio-oil outlet 1650 adapted to output bio-oil 1060 with the finer dust particulates. The syngas 1080 exiting the clean syngas outlet 1640 may be mixed with a second form of steam 1232 at a fourth temperature.
The oil-gas separator 1600 may be adapted to receive the finer pyrogas 1082 from the dust separator 1500 and use a jet stream of water droplets 1622 to separate bio-oil 1060 including fine dust particulates from the finer pyrogas 1082 and also create a clean syngas 1080.
By way of example, the clean syngas 1080 may be adapted to fuel the furnace 1100.

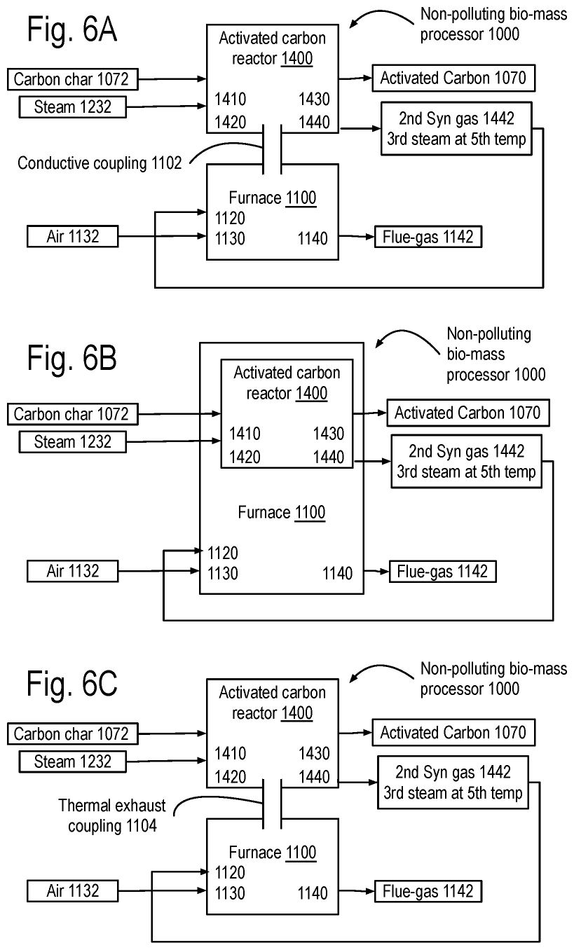

FIG. 6A to FIG. 6C show simplified block diagrams of alternative implementations of the furnace 1100 of FIG. 5A and the activated carbon reactor 1400 of FIG. 5D as details of alternative implementations of the non-polluting biomass processor 1000 of FIG. 1.
FIG. 6A differs from previous drawings by showing the activated carbon reactor 1400 connected by a conductive coupling 1102 with the furnace 1100 to at least partly support operating the activated carbon reactor 1400 at about the first temperature 1110 of the furnace 1100. The syngas outlet 1440 through which the second form of syngas 1442 mixed with the third form of steam at the third temperature is fed into the furnace 1100 at its syngas inlet 1120.
FIG. 6B differs from previous drawings by showing the activated carbon reactor 1400 included in the furnace 1100 to at least partly support operating the activated carbon reactor 1400 at about the first temperature 1110 of the furnace 1100. In some implementations, the activated carbon reactor 1400 may be adapted for insertion into the furnace 1100.
FIG. 6C differs from previous drawings by showing the activated carbon reactor 1400 connected by a thermal exhaust coupling 1104 with the furnace 1100 to at least partly support operating the activated carbon reactor 1400 at about the first temperature 1110 of the furnace 1100.

Note that further alternatives include combinations of one or more of the above examples shown in FIG. 6A to FIG. 6C.
For a first example, there may be more than one conductive coupling 1102 in an implementation of the activated carbon reactor 1400 and the furnace 1100 adapted for use in the non-polluting biomass processor 1000.
As a second example, the activated carbon reactor 1400 may be included in the furnace 1100, and there may be a conductive coupling 1102 between them.
As a third example, there may be more than one thermal exhaust coupling 1104 feeding the activated carbon reactor 1400 from the furnace 1100.
As a fourth example, the activated carbon reactor 1400 may be included in the furnace 1100 as in FIG. 6B and there may be a conductive coupling 1102 as in FIG. 6A and an exhaust coupling 1104 as in FIG. 6C.

Note that in some situations, the activated carbon reactor 1400 and the furnace 1100 may be constructed separately and upon installation one or more of the situations shown in FIG. 6A to FIG. 6C may be implemented. Note that the activated carbon reactor 1400 and the furnace 1100 may be manufactured by separate entities and their installation may be carried out by a third entity.

FIG. 7A to FIG. 7E show examples of the non-polluting biomass processor 1000 using distinct combinations of the manufactured processor components discussed above.

FIG. 7A shows simplified block diagrams of an example implementation of the non-polluting biomass processor 1000 of FIG. 1 including the furnace 1100, the boiler 1300, and the thermal assembly 1200. The non-polluting biomass processor 1000 further includes these units interacting as follows:
The furnace 1100 of FIG. 2A may be adapted to receive air 1132 into its air inlet 1130, and the gaseous fuel 1150, possibly syngas 1080, into its syngas inlet 1120. When starting up the biomass processor 1000, the gaseous fuel 1150 may be some form of natural gas, stored syngas 1080, or liquefied fuel, which is converted to gaseous form. Once started, the furnace 1100 may operate mostly, and in some cases, exclusively based upon syngas 1080 generated by the biomass processor 1000. In response to receiving the air 1132 and the syngas 1080, and operating at the first temperature 1110 as shown in FIG. 2A, the furnace 1100 outputs the flue-gas 1142 at the second temperature 1144 through its flue-gas outlet 1140.
The boiler 1300 of FIG. 5C may be adapted to receive clean water 1322 into its [symbol] to create the steam 1232, which is distributed to the thermal assembly 1200 and the oil-gas separator 1600.
The thermal assembly 1200 of FIG. 5B may be adapted to receive the flue-gas 1142 at the second temperature 1144 output by the furnace 1100, the steam 1232 output by the boiler 1300 at about the boiling point of water and to receive the biomass feedstock 1010 input to the non-polluting biomass processor 1000 as shown in FIG. 1. The thermal assembly 1200 may output pyro-gas 1082, possibly mixed with a second steam 1272 through pyro-gas outlet 1250. The output pyro-gas and steam may be transferred to a second biomass processor 1000, which may contain a dust separator 1500, as shown in FIG. 7B to FIG. 7E. This may be a useful combination in any of several situations. For example, in an installation containing more than one biomass processor 1000, the cost of the dust separator 1500 may be shared.

FIG. 7B and FIG. 7C show refinements of FIG. 7A as simplified block diagrams of an example implementation of the non-polluting biomass processor 1000 of FIG. 1 including the furnace 1100, the boiler 1300, the thermal assembly 1200, the oil-gas separator 1600, and the dust separator 1500. FIG. 7B and FIG. 7C differ in that the gaseous fuel 1150 feeding furnace 1100 is externally provided in FIG. 7B and is provided by feedback of the syngas 1080 output from the oil-gas separator 1600 in FIG. 7C. The non-polluting biomass processor 1000 further includes these units interacting as follows:
The oil-gas separator 1600 of FIG. 5G may be adapted to receive the steam 1232 from the boiler 1300 to maintain a jet stream of water droplets 1622 and the sixth temperature 1602 of about the boiling point of water, which is often regarded as 100 degrees C. at or near sea level. The oil-gas separator 1600 responds to receiving the finer pyrogas 1082 from the dust separator 1500 and a jet stream of water droplets 1622 by separating bio-oil 1060 from a clean syngas 1080. The bio-oil 1060 includes the finer dust particulates of the finer pyrogas 1082 which are not present in the clean syngas 1080. By way of example, the clean syngas 1080 may be adapted to fuel the furnace 1100.

FIG. 7D shows a refinement of the drawing of FIG. 7B showing the non-polluting biomass processor 1000 includes the activated carbon reactor 1400 interacting with the furnace 1100. The non-polluting biomass processor 1000 further includes these units interacting as follows:
The activated carbon reactor 1400 of FIG. 5D may be adapted to be close, [symbol] operating at the first temperature 1110 also heats the activated carbon reactor 1400 to about the first temperature 1110. The activated carbon reactor 1400 may be adapted to receive, through the steam inlet 1420, the steam 1232 from the boiler 1300 at about the boiling point of water, and also to receive, through the carbon char 1072 inlet 1410, the carbon char 1072 from the thermal assembly 1200.
The furnace 1100 of FIG. 5A may be adapted to receive air 1132 into its air inlet 1130, and the syngas 1080 into its syngas inlet 1120. In response to receiving the air 1132 and the syngas 1080, and operating at the first temperature 1110 as shown in FIG. 2A, the furnace 1100 outputs the flue-gas 1142 at the second temperature 1144 through its flue-gas outlet 1140.

FIG. 7E shows a refinement of the drawing of FIG. 7A showing the non-polluting biomass processor 1000 includes the dust separator 1500 adapted and configured to receive the pyro-gas 1082 and second steam 1272 output from the thermal assembly 1200. The dust separator 1500 responds to the pyro-gas 1082 and second steam 1272 to generate the finer pyro-gas 1082 and second steam at the fourth temperature, which is sent to the furnace 1100. The dust separator 1500 also generates the large dust 1532 as an output.

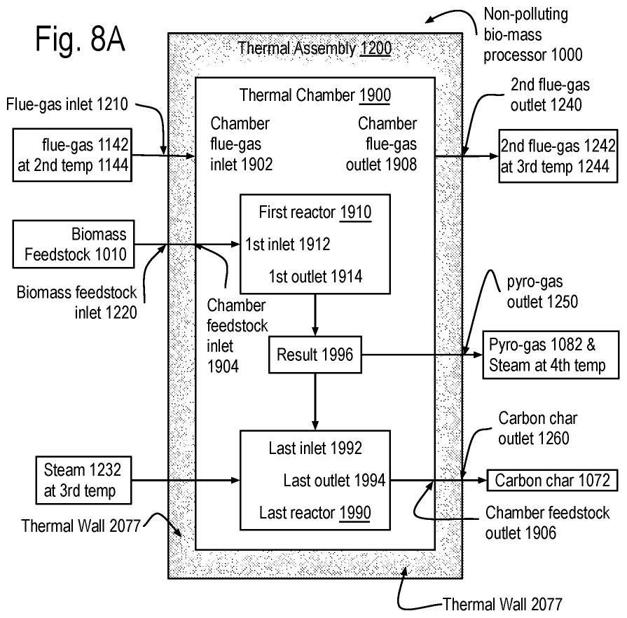

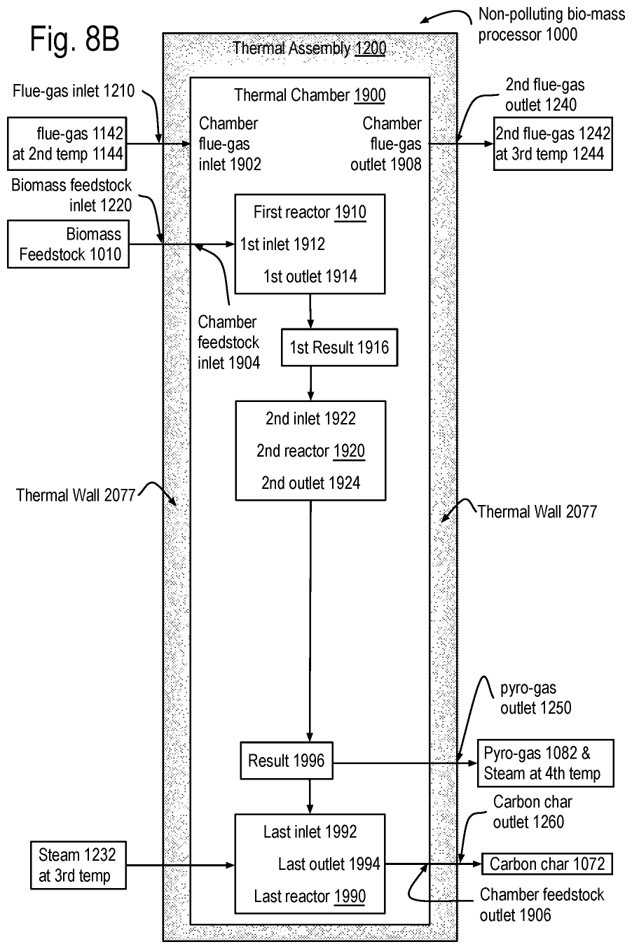

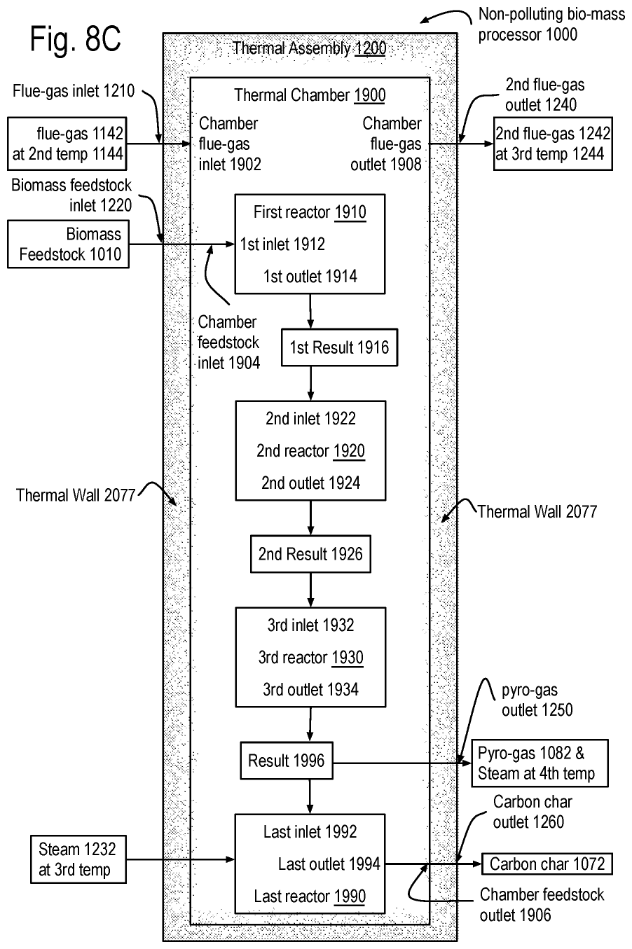

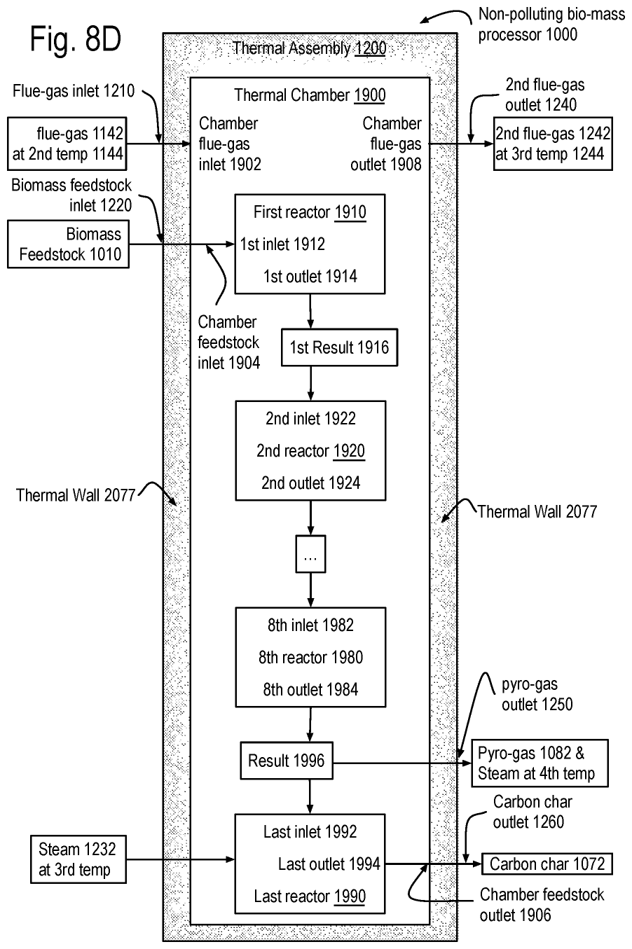

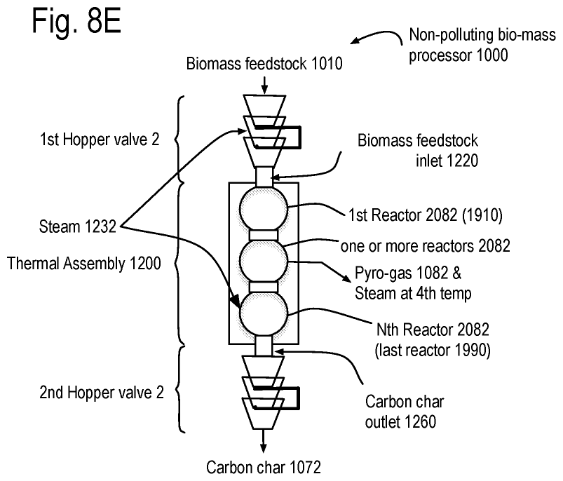

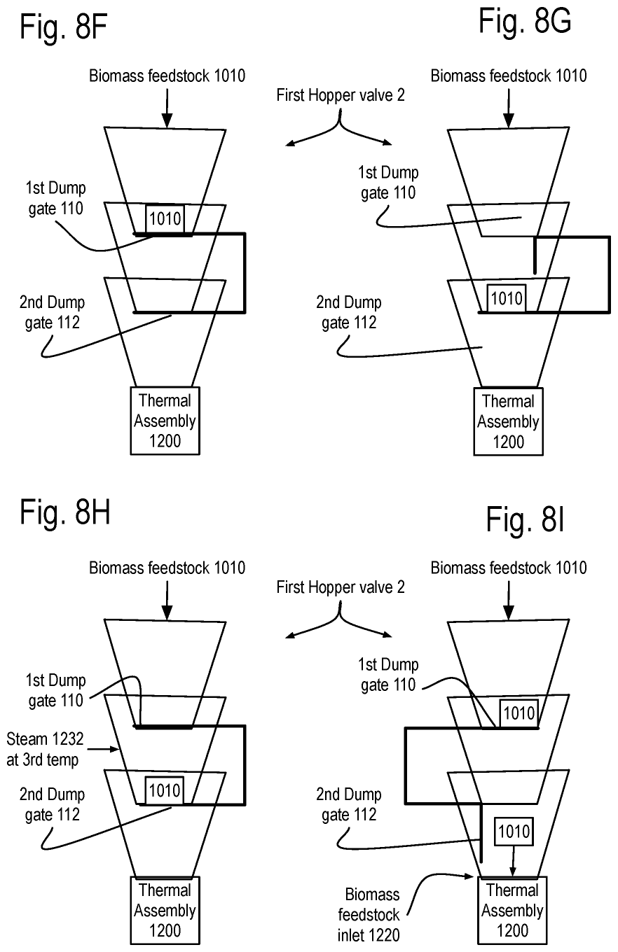

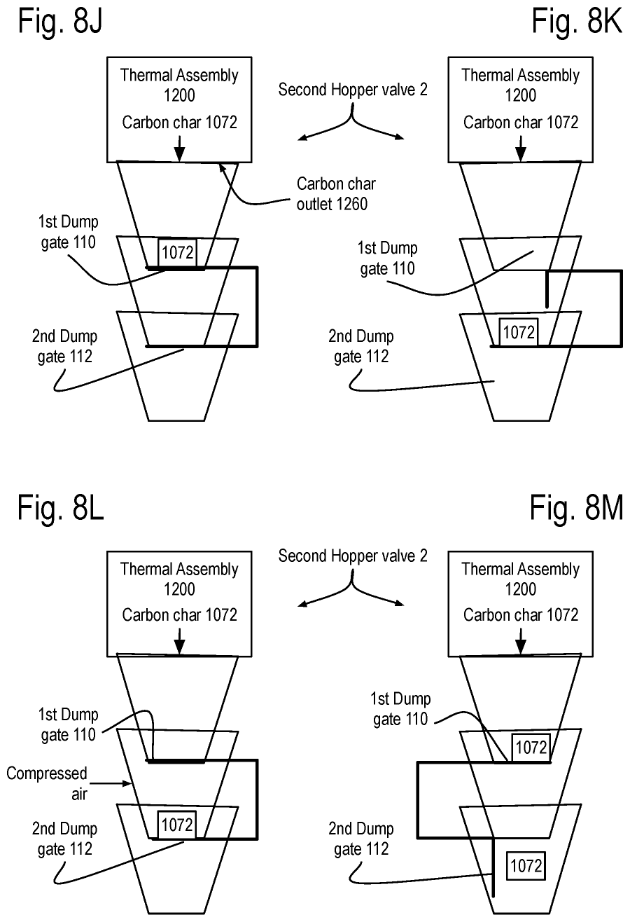

FIG. 8A to FIG. 8E show simplified block diagrams of some alternative implementation details of the thermal assembly 1200 and of the non-polluting biomass processor 1000, which differ from what has been previously presented.

FIG. 8A shows an example of the thermal assembly 1200 including a thermal chamber 1900 containing a first reactor 1910 and a last reactor 1990. The thermal assembly 1200, and its thermal chamber 1900, may respectively include
a flue-gas inlet 1210 adapted to feed a chamber flue-gas inlet 1902,
a biomass feedstock inlet 1220 adapted to feed a chamber feedstock inlet 1904 further adapted to feed a first inlet 1912 of the first reactor 1910,
steam 1232 at a third temperature is provided from a source outside the thermal assembly 1200 to the last reactor 1990,
The thermal chamber 1900 may include a chamber flue-gas outlet 1908 adapted to feed a second flue-gas outlet 1240 included in the thermal assembly 1200.

The first reactor 1910 may include a first outlet 1914 adapted to output a result 1996, which may be presented to the last inlet 1992 of the last reactor 1990.

The result 1996 may also be output from both the thermal chamber 1900 and the thermal assembly 1200 as the pyro-gas 1082 at a fourth temperature.

The last reactor 1990 may be adapted to respond to the result 1996 entering through the last inlet 1992, and the steam 1232 at the third temperature to emit carbon char 1072 through the last outlet 1994 adapted to the chamber feedstock outlet 1906 in the thermal chamber 1900, which in turn is adapted to align with the carbon char outlet 1260 of the thermal assembly 1200.

FIG. 8B shows the thermal assembly 1200 of FIG. 8A further including a second reactor 1920. FIG. 8B differs from FIG. 8A as follows: The first reactor 1910 includes the first outlet 1914 which produces a first result 1916 which feeds a second inlet 1922 of the second reactor 1920. The second reactor 1920 also includes a second outlet 1924, which generates the result 1996.

FIG. 8C shows the thermal assembly 1200 of FIG. 8B further including a third reactor 1930. FIG. 8C differs from FIG. 8B as follows: The second reactor 1920 includes the second outlet 1924, which generates the second result 1926, which feeds a third inlet 1932 included in the third reactor 1930. The third reactor includes a third outlet 1934 which generates the result 1996.

FIG. 8D shows the thermal assembly 1200 as previously presented including a total of 9 reactors, including all the reactors 1910, 1920, 1990 of FIG. 8C. FIG. 8D differs from FIG. 8B as follows: The second reactor 1920 includes the second outlet 1924, which generates the second result 1926, which feeds a third inlet 1932 included in the third reactor 1930. The third reactor include a third outlet 1934 which generates the result 1996. This is continued in the same fashion until the eighth reactor 1980 receives through the eighth inlet 1982, the output of the previous, seventh reactor. The eighth reactor also includes an eighth outlet 1984 which generates the result 1996.

FIG. 8E shows some details of the thermal assembly 1200 receiving the biomass feedstock 1010 mixed with pressurized steam 1232 as the input lacking air into a first reactor 2082 (also known as reactor 1910), heats the feedstock 1010 through two or more additional reactors 2082, generating a pyrolysis gas 1082 and steam at a fourth temperature in the process, as well as carbon char 1072 as output.

FIG. 8F to FIG. 8I show the operation of the first dump gate 110 and the second dump gate 112 of the first hopper valve 2 of FIG. 8E to create a biomass input cycle into the thermal assembly 1200.
In FIG. 8F, the first hopper valve 2 is operated to receive biomass feedstock 1010 into the hopper valve 2 as the start of a biomass input cycle to feed the thermal assembly 1200. The first dump gate 110 is closed, and the biomass feedstock 1010 accumulates at the first dump gate 110. The second hopper gate 112 is closed, to complete the previous biomass input cycle, sealing the thermal assembly 1200.
In FIG. 8G, after the first hopper valve 2 had been closed, as shown in FIG. 8F, long enough for sufficient biomass feedstock 1010 to accumulate on the first dump gate 110, the first dump gate 110 is opened as shown here, causing the accumulated biomass feedstock 1010 to accumulate at the second dump gate 112.
In FIG. 8H, the first dump gate 110 is then closed and the chamber formed between the first dump gate 110 and the second dump gate 112 is now sealed. Steam 1232 at a third temperature enters the chamber and the air is replaced.
In FIG. 8I, once the chamber formed by the first dump gate 110 and the second dump gate 112 is saturated with the steam 1232 shown entering the chamber in FIG. 8H, the second dump gate 112 is opened as shown in FIG. 8I, causing the accumulated biomass 1010 to enter the thermal assembly 1200, in a condition which limits the possibility of explosion in the thermal assembly 1200.

FIG. 8J to FIG. 8M show the operation of the first dump gate 110 and the second dump gate 112 of the second hopper valve 2 of FIG. 8E to create a carbon char output cycle from the thermal assembly 1200.
In FIG. 8J, the second hopper valve 2 is operated to receive carbon char 1072 into the hopper valve 2 as the start of a carbon char output cycle to feed the thermal assembly 1200. The first dump gate 110 is closed, and the carbon char 1072 accumulates at the first dump gate 110. The second hopper gate 112 is closed, to complete the previous carbon char output cycle, sealing the thermal assembly 1200.
In FIG. 8K, after the second hopper valve 2 had been closed, as shown in FIG. 8J, long enough for sufficient carbon char 1072 to accumulate on the first dump gate 110, the first dump gate 110 is opened as shown here, causing the accumulated carbon char 1072 to accumulate at the second dump gate 112.
In FIG. 8L, the first dump gate 110 is then closed and the chamber formed between the first dump gate 110 and the second dump gate 112 is now sealed. Compressed air enters the chamber.
In FIG. 8M, once the chamber formed by the first dump gate 110 and the second dump gate 112 is saturated with the air shown entering the chamber in FIG. 8L, the second dump gate 112 is opened as shown in FIG. 8M, causing the accumulated carbon char 1072 to enter the thermal assembly 1200, in a condition which limits the possibility of explosion

[symbol]

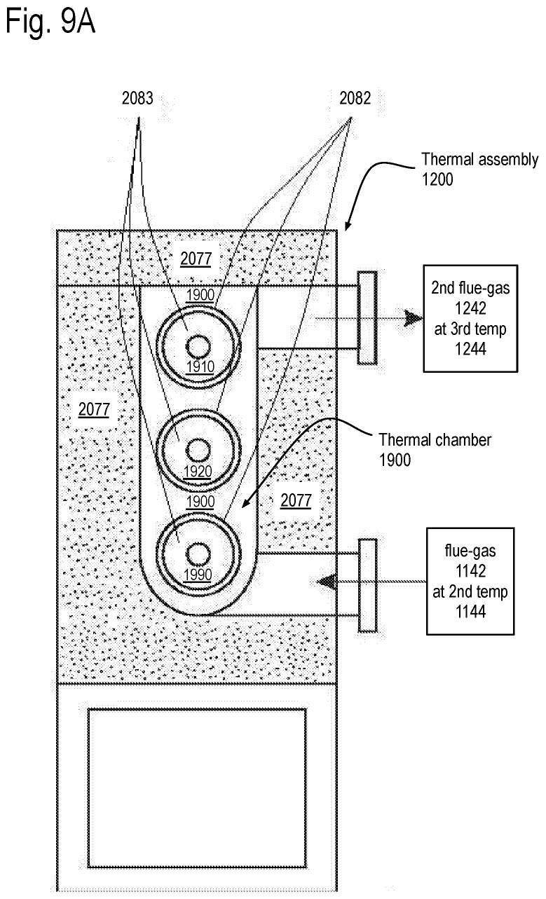

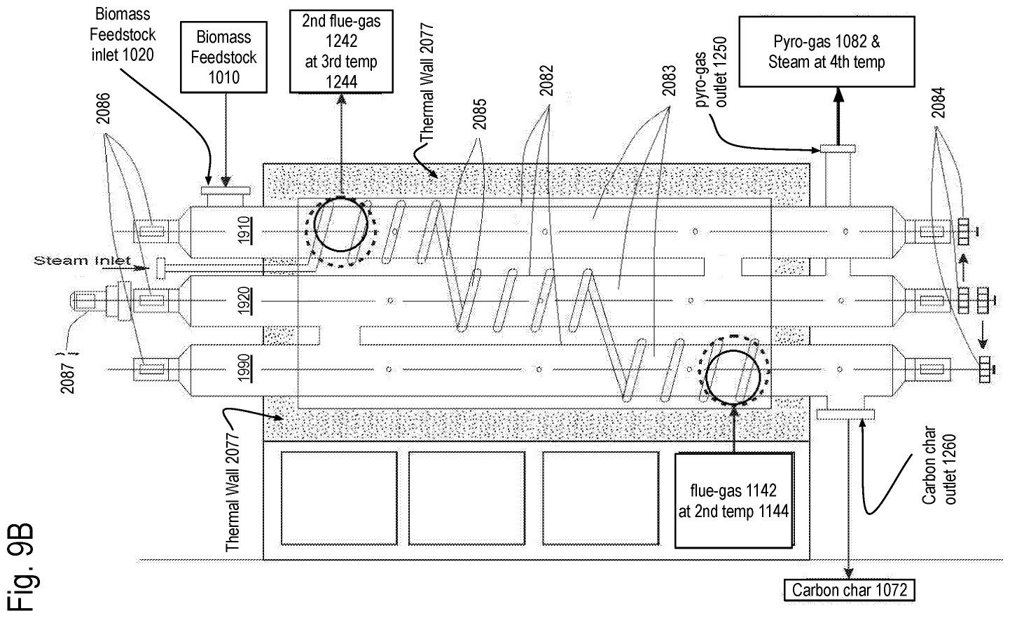

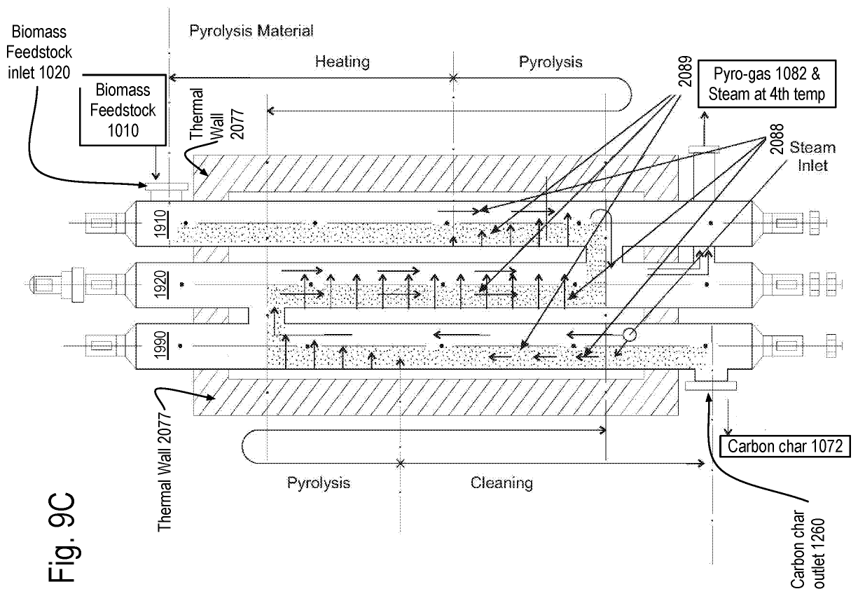

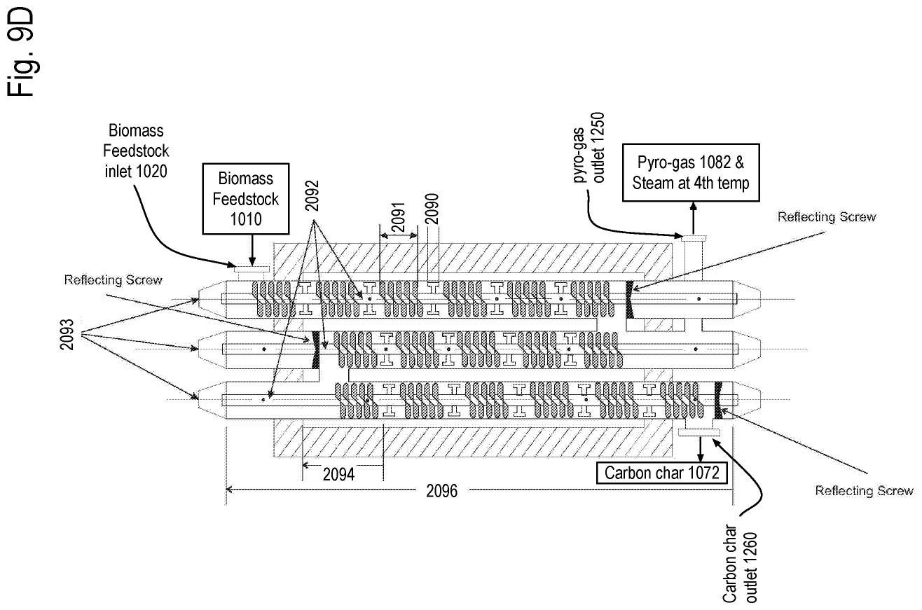

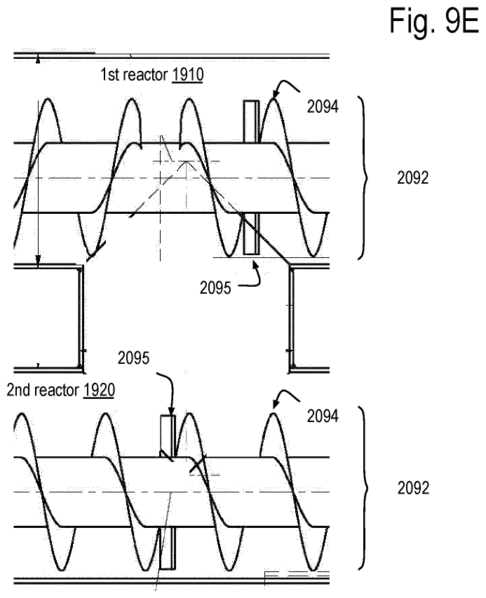

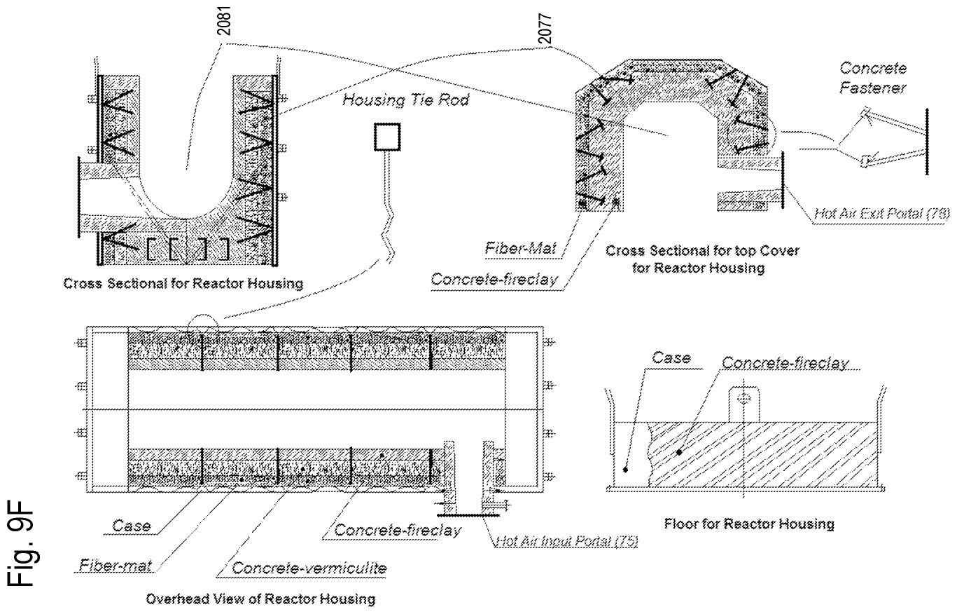

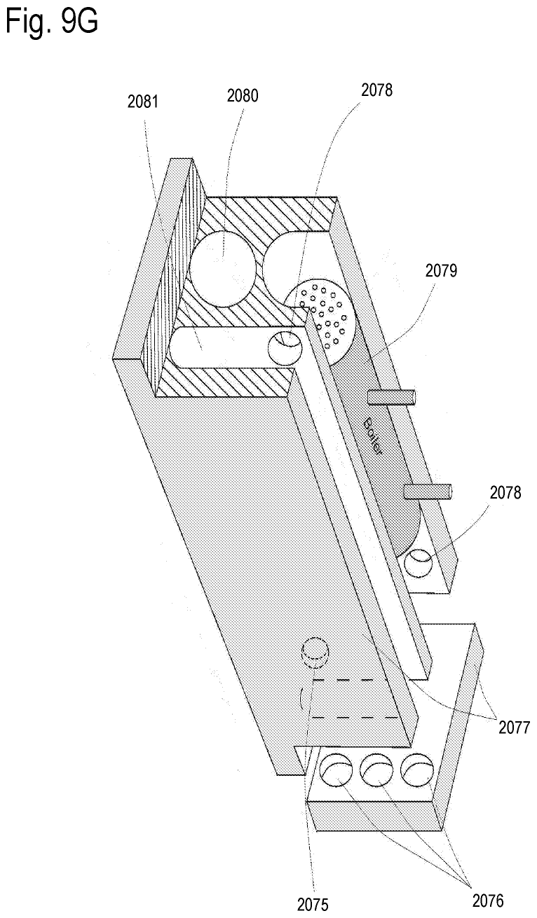

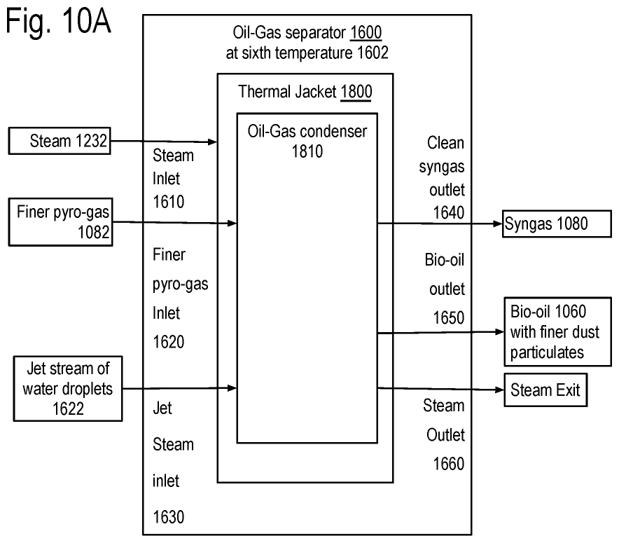

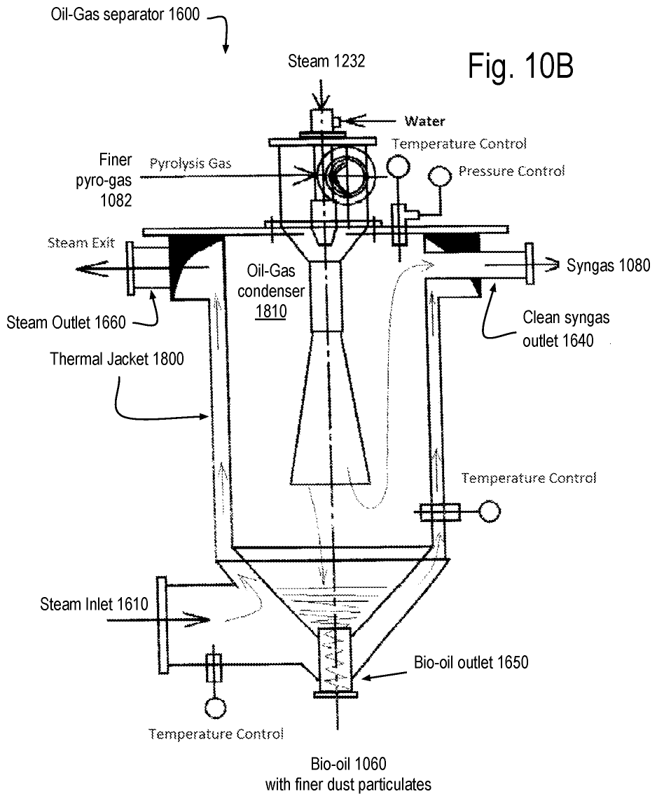

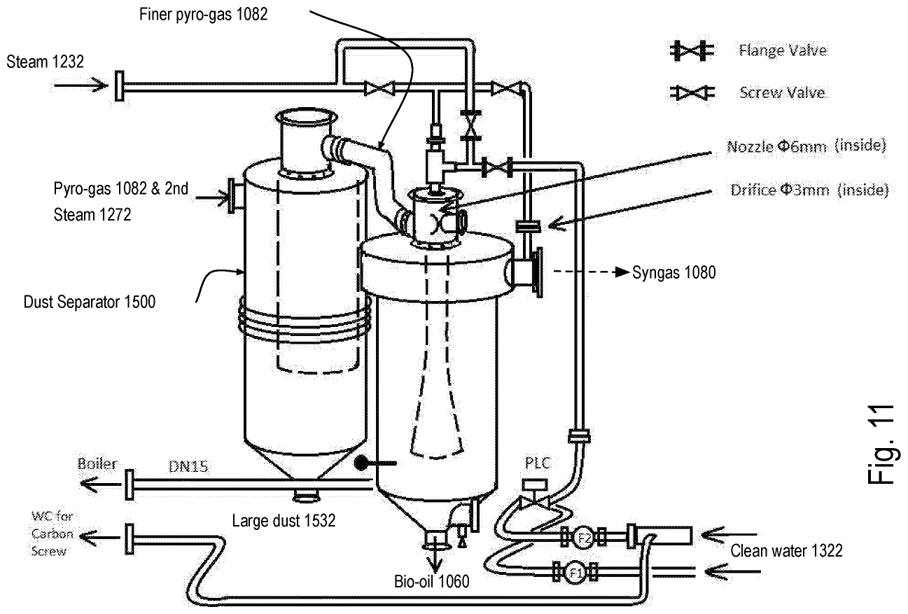

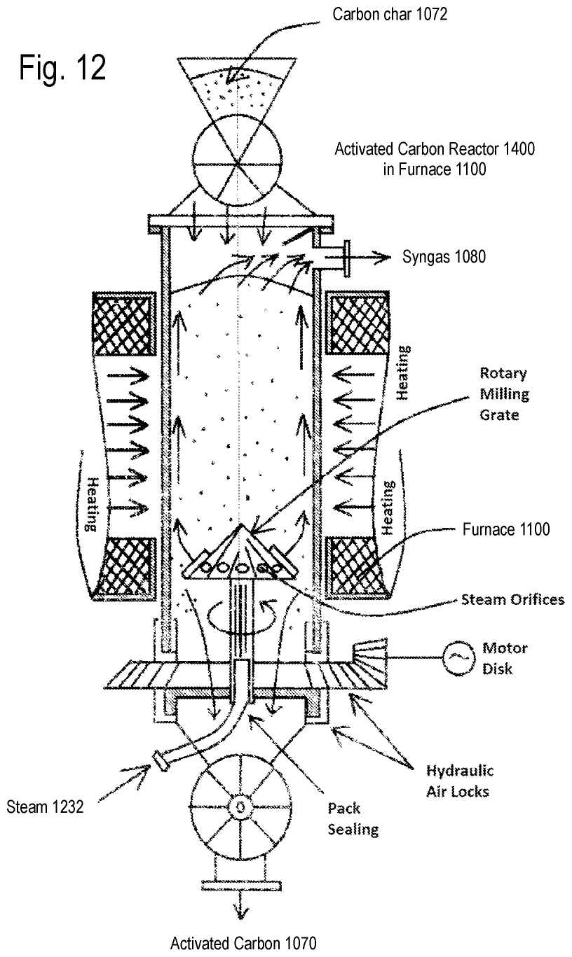

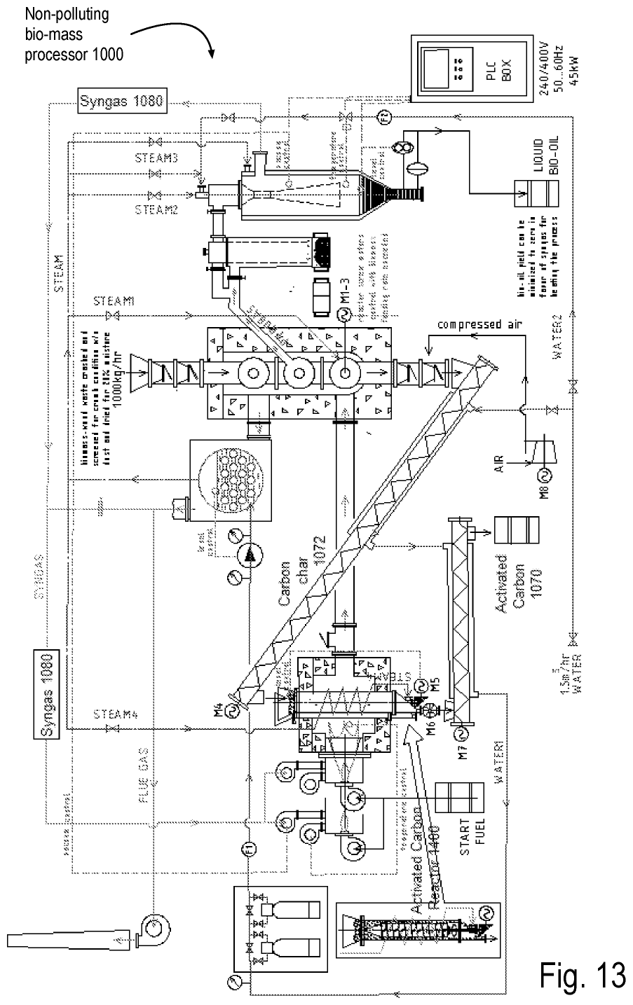

FIG. 9A to FIG. 9G show some details relevant to at least some implementations of the thermal assembly 1200 and their relationship to some alternative embodiments of the non-polluting biomass processor 1000.
FIG. 9A shows a side view of the thermal assembly 1200 of FIG. 5B and FIG. 7A to FIG. 8D including three reactors 2082, corresponding to the first reactor 1910, the second reactor 1920, and a third, last reactor 1990, all housed in the thermal chamber 1900. FIG. 9B shows a cross section view of the thermal assembly 1200.
FIG. 9A and FIG. 9B collectively show an embodiment of thermal assembly 1200 containing three reactors 2082 installed one next the other, each having a charge opening and a discharge opening which are connected to each other and first (loading) and second (unloading) hoppers valves 2. Each of the reactors 2082 is provided with one axial transporting structure 2092 and each transporting structure 2092 is connected to a corresponding driving device 2087. Each of the transporting structures comprises of a plurality of spiral segments 2094 and a plurality of paddle segments 2095. Feedstock material is fed through the charge opening of the upper reactor 2082 and into the reaction chamber 2083 and pyrolyzed therein. The pyro-oil-gas is discharged out through the pyro-oil-gas outlet located in the second reactor, while pyro-solid-materials by-products are fed from the first reactor into the second reactor and the third reactor and discharged out the discharge opening in the third reactor and the reaction chamber.
FIG. 9C shows the feedstock materials decomposition process with pyrolysis gases and steam flow through the reactors. The materials are loaded through a charge opening in the first tubular reaction chamber into the first reactor 2082 (also known as 1910) and gradually moved forward by rotating the transporting structure providing a heating and pyrolysis processing zone in the method of this invention along the central axis of the transporting structure. During the pyrolysis reaction the volatiles from the feedstock materials and carbon black 2089 are released. During the transporting course the feedstock materials stay temporarily in the paddle segments 2095 to be stirred and blended by the rotating paddles 2095 of the paddle segments providing a blending zone in the method of this invention.
FIG. 9D is a cross sectional view of an embodiment of a pyrolysis reaction chamber for implementing the blending method of this disclosure and illustrates pyrolysis reactors 2082. The pyrolysis reactors 2082 comprise a tubular reaction [symbol] outlet, a discharge outlet and a communicating opening between the reactors 2082. The tubular reaction chamber 2083 which functions as a reactor for carrying out the pyrolysis process and the method of this disclosure comprises a first reactor 2082 (also known as 1910), a second reactor 2082 (also known as 1920) and a third reactor 2082 (also known as 1990) installed one above the other which communicate with each other through the communicating openings. Each of the reactors 2082 encompasses an axial transporting device 2092 and each transporting device is connected to a driving device 2087 by a chain-wheel devices 2084 connected from the central driving device 2087 to the other axial transporting devices located in the upper and lower reactors. Each of the transporting devices 2092 has a central axis and comprises a plurality of spiral segments 2094 and a plurality of paddle segments 2095. The total length of the spiral segments 2094 and paddle segments 2095 are respectively calculated by summing the length of each segment along the direction of the central axis 2096. Generally, the total length of the paddle segments 2095 of each transporting structure 2092 ranges from 5% to 35% of the length of the transporting structure 2096. FIG. 9D shows the jet stream generated by an external jet stream generator to the oil-gas separator 1600.
Note that in some embodiments, the axial transporting devices 2092 of different reactors 2082 may be driven by separate driving devices 2087. Also note, the reactor 2082 may have distinctly different sizes. For example, the last reactor 1990 may be much larger the preceding reactors 2082. This may be advantageous when maximizing the quantity and quality of the carbon char 1072 produced by the thermal assembly 1200. An implementation of the non-polluting biomass processor 1000 as shown in FIG. 7A may use such an implementation of the thermal assembly 1200.
FIG. 9E show some details of an augur system that may be used in one or more of the reactors 2082. Note that the reactors 2082 may or may not all use the same kind of augurs.
FIG. 9F shows cross sectional drawings representing side and overhead views of a preferred embodiment of the containment housing for the reaction chamber.
FIG. 9G shows isometric drawings representing an alternative embodiment of the containment housing for the reaction chamber which encases the furnace and steam boiler.

FIG. 9A to FIG. 9D, FIG. 9F and FIG. 9G, show an implementation of the reaction chamber 1900 first shown in FIG. 8B, containing three reactors 2082 and carrying out a [symbol] passes through one or more proceeding zones 2094 and one or more blending zones 2095 in each reactor 2093, the material to be pyrolyzed passing from the first reactor 2093 to the second reactor 2093 and then the third or more reactors. The total length of one or more blending zones in each reactor may range from about 5% to 35%. The reactors 2082 may utilize high-temperature steam 1232 and a re-circulating heat source to crack dioxin and organic substances contained in the biomass feedstock 1010. The off gas mixture (referred to elsewhere in this disclosure as flue-gas 1242) produced in the reactors 2082 may be discharged into an off gas mixture treatment system including an oil-gas separator 1600 first shown in FIG. 5G for separation at a temperature between 100° C. to 110° C. The used steam and syngas 1080 after separation from the bio-oil 1060 are both re-introduced into a furnace 1100 for producing heat.

Various implementations of the biomass processor 1000 support a method of operation of the thermal assembly 1200 for pyrolyzing biomass feedstock 1010 including used tires, shown through use of FIG. 5B, Fig. FIG. 8A to Fig. FIG. 8E, FIG. 9A to FIG. 9G, as follows:

A biomass feedstock inlet 1220 in the first reactor 1910 and carbon char outlet 1260 in the third or last reactor 1990 of three or more reactors 2082 installed in the thermal chamber 1900. Each of the transporting structures 2092 in each reactor 2082 has a central axis and may comprise a plurality of spiral structures 2094 starting from the opening charge and continuing through in a forward direction from the entry into the first reactor and into a second reactor and moving forward from the opening charge of the second reactor and continuing into a third or additional reactor. The spiral structures start at the opening charge and continue forward to the discharge of the third reactor. Each reactor 2082 containing a plurality of paddle structures 2095 disposed along the axis direction. Each of the transporting structures 2092 contained in each reactor 2082 may include paddle segments 2095 of substantially the same in width and length and each of spiral segments 2094 may be substantially identical in width and length. Often the total length of paddle segments ranges from 5% to 30% of the length of the transporting structure 2096 and a loading limit of feedstock to not more than 50% of the volume of the first reactor as the biomass feedstock 1010, the amount to be determined based by a commonly understood approximation upon the diameter and length of the first reactor 2096. In some embodiments, the augers are rotated by a gear motor 2087 having a continuous variable transmission with a speed sensors 2086. A gear-motor may be mounted on the second screw auger from which chain gears 2084 rotate the other 2 screw augers. Because the transporting structure 2092 of this disclosure comprises paddle segments 2095, the biomass feedstock 1010 is stirred and blended thereby permitting a thorough penetration of the feedstock material by the superheated steam 2085, which affects a more complete and homogeneous pyrolysis of the feedstock material.

The screw augers 2091 located in the reactors 2082 may be driven by any appropriate driving means 2087, in some embodiments, this is a reduction electric motor, while the rotational speed of the axial transporting structures 2092 can be adjusted depending on the size, composition and time required to optimize the decomposition of the biomass feedstock 1010 into the desired specification of the by-products, such as the pyro-gas 1082 and/or the carbon char 1072, based upon the processor configuration 1020 shown in FIG. 1. In the some embodiments, the reactors 2082, the transporting structures 2092 and blending blades 2095 are made of stainless steel SS 321.

The injected superheated steam 2088 unclogs and displaces the volatiles 2089 contained in the biomass feedstock 1010 and the carbon char 1072 produced from the pyrolysis process and creates a thorough steam diffusion of the volatiles 2089 in the biomass feedstock 1010 and the carbon char 1072 in the reactors 2082. The presence of superheated steam 2088 reduces the pyrolysis temperature required below that of the current pyrolysis systems which do not use steam thereby increasing the energy efficiency of the biomass processor 1000. Further, the injected steam assists in reducing the vacuum created by pyrolysis systems which do not use steam, thereby assisting in eliminating the danger of air entering into the reactors 2082 and the possibility of a resulting explosion of the pyro-gas 1082 produced. To further assist in removing this danger, the invention incorporates a steam generation system, referred to in some embodiments as a boiler 1300 whereby the injected steam represents not more than 30%-35% by weight in relation to the weight of the biomass feedstock 1010.

In several embodiments, the superheated steam 1232 is injected into an opening (a steam inlet) in the third reactor 2082 at the temperature of 400 degrees C. to 450 degrees C. and then continuing through that reactor into the second and then the first reactors as shown in FIG. 8B and FIG. 8E. The superheated steam is discharged, either through a steam and pyrolysis gas outlet opening in either the first or second reactor, together with the off-gas created from the pyrolysis process at the off-gas and steam discharge opening .

Embodiments of the apparatus include the non-polluting bio-mass processor 1000 shown in FIG. 8E containing a first hopper valve 2 for loading the thermal assembly 1200 prior to the entry of the biomass feedstock 1010 into the first reactor 2082 (also known as the first reactor 1910) and a second hopper valves 2 at the carbon char outlet 1260 for the unloading of the third reactor 2082 (also known as the last reactor 1990) by operating a second hopper valve [symbol] biomass feedstock 1010 to be pyrolyzed. The second hopper valve 2 prevents air from entering the rectors 2082 from the second hopper valve 2 when unloading the carbon char 1072 at the carbon char outlet 1260 of the third reactor 2018 (also known as the last reactor 1990). The operation of the first hopper valve 2 is shown in FIG. 8F to FIG. 8I. The operation of the second hopper valve 2 is shown in FIG. 8J to FIG. 8M.

This disclosure provides a vacuum fan 18 in the first hopper valve 2 to continually extract any present outside air in the first hopper which may be sent to the post-combustion furnace 1100 for burning. This helps eliminate unpleasant odors emanating from the reactors 2082 while at the same time assisting in restricting air from entering the reactors 2082. This further assists in maintaining the reactor integrity and fan dilution.

The furnace 1100 may be equipped with an automatic burner 2019 for liquid fuel with a three stage regime of regulation which allows the production of heat to the reaction chamber 2082 when starting the pyrolysis process and as a source of ignition to support the after burning of residual gaseous by-product produced from pyrolysis, referred to as a flue-gas 1242. Some embodiments may have a flow rate of 75-80 litres of fuel per hour and a flow rate of 15-20 litres per hour relative to the 1,000 kgs/hr of tire pyrolysis rate. Ignition is produced in a small chamber before the main chamber as shown in FIG. 13, where in a narrow annulus around the pipe burner, a mixing of the syn fuel 1080 and/or pyrogas 1142 or 1242 with air 1132 to achieve combustion and heat residual having the intensity of fuel oil. Channel size and speed of the vapor-gas mixture in it are determined by those familiar with the art.

The temperature in the furnace 1100 may be within the range of 900 degrees C. to 1100 degrees C. and may be controlled by two regulators operating at 900 degrees C. to 1000 degrees C. and the other subsequently at 1000 degrees C. to 1100 degrees C. Both regulators may operate continuously and in cohesion with each other. The first may be an automatic regulator within a burner in the furnace 1100, which controls the amount of diesel fuel, syn fuel 1080, or gaseous fuel 1150 consumed when starting the pyrolysis process and secondly by an automatic control for firing through using a pair of bypass valves controlling the supply of gaseous by-products, such as syngas 1180, or pyro-gas 1082 from the oil-gas separator 1600. When in a continuous operation mode, the more of the gaseous material that passes, the less steam in the system and the higher the temperature in the furnace 1100 and vice versa. A fan may supply air 1132 to the combustion chamber of the furnace 1100. The fan may supply syngas 1080 including steam at a fourth temperature that come from the oil-gas separator 1600 with a temperature slightly above 100 degrees C. The volume of these may be controlled by a regulator.

The thermal assembly 1200 disclosure is focused on including 3 tubular reaction chambers labeled 1910, 1920 and 1990 in FIG. 8B and shown in further detail labelled as 2082 in FIG. 9A, FIG. 9B, FIG. 9C, FIG. 9D, FIG. 9E, FIG. 9F as well as in FIG. 13. In some embodiments the biomass feedstock 1010 is loaded into the first reactor 2082 (being the upper reactor) having the surface wall temperature between 300 degrees C. to 400 degrees C. The feedstock material is moved along the length of the first reactor to the second reactor 2082 which has a temperature of between 400 degrees C. to 500 degrees C. and to the third reactor 2082 which is located below and has a temperature of between 500 degrees C. to 600 degrees C. In some implementations, the total time spent by the biomass feedstock 1010 in the reactor chambers 2083 prior to being discharged may be approximately 17 minutes, during which time the temperature of the feedstock materials will reach between 400 degrees C. to 450 degrees C. In some embodiments, the first reactor 1910 (2082) and the second reactor 1920 are made with stainless steel SS321 and the third (last) reactor 1990 may be made with stainless steel SS310. The time for processing the biomass feedstock 1010 may be varied by those familiar with the art by varying the speed of the screw augers so as to produce the desired grade of carbon black or activated carbon.

Many embodiments of the biomass processor 1000 include a screw conveyor with an external cooling jacket which cools the temperature of the carbon char 1072 at the carbon char outlet 1260 of the thermal assembly 1200 from approximately 400 degrees C. to approximately 50 degrees C. This apparatus may be cooled by water from a cooling tower, which may circulate the water in an outer jacket opposite the direction of the screw auger.

The biomass processor 1000 may include a boiler 1300 adapted and configured to produce a sufficient supply of steam 1232 for the efficient thermal decomposition of the biomass feedstock 1010 in the reactors 2082 of the thermal assembly 1200 and stable condensation of syngas 1080 in the thermal assembly 1200. In some embodiments of the bio-mass processor 1000 the steam 1232 may be generated at temperatures up to 150 degrees C. and at a pressure of 5 bars from water 1322 diverted from the oil-gas separator 1600, which condenses the exhaust steam contained in flue gas 1142 after the off-gas burning in the furnace 1100 which is firstly generated from the reactors 2082 of the thermal assembly 1200 together with the residual steam from the oil-gas separator 1600 thereby collecting all water in the steam and reusing it to produce steam again. The volume of steam and the pressure to be generated required is commonly known to those familiar in the art.

The apparatus may include a fan-exhauster which draws furnace gases from the reaction [symbol] 200 degrees C. to 250 degrees C. The size of the boiler 1300 may be determined by special calculations performed by those familiar in the art and known to the industry. In one embodiment, a level sensor permits adjustment of the amount of water 1322 entering the boiler 1300, so as to maintain the required amount of water in the installation. From the boiler 1300, steam 1232 may be sent to a tubular super heater 2085 contained in the thermal assembly 1200 to heat the steam 1232 to temperature of 400 degrees C. to 450 degrees C., which is then fed directly into the reactors 2082 for contact with the biomass feedstock 1010 to be pyrolyzed in a volume which is determined and controlled by one or more temperature sensors. Together with pyro-gas 1082, the superheated steam 1272 then goes to the oil-gas separator 1600 where the pyro-gas 1082 is sent for evaporative spray cooling by water and combined as a residue with the steam for burning in the furnace 1100.

A water flow rate of 200 to 250 kg/hr for a 1,000 kgs/hr used tire feedstock may be optimal in some implementations. A slight discharge of excess steam in the scrubber oil-gas separator 1600 permits the adjustment of the amount of vapor in the condensation process and the temperature of the combined-cycle steam with after-burning of the off-gas in the furnace 1100. The water in the steam coming from the scrubber may have an increased pH ≥8.5 (alkaline). In some embodiments, the boiler 1300 may be constructed of corrosion-resistant stainless steel. In addition, the direct gas pipes are of the type that provide for open access as illustrated in FIG. 13 for the purpose of cleaning the pipes from soot, which is present in the off gases and accumulates in the pipes during the combustion of the pyrolysis fuel.

FIG. 13 shows some further details of the non-polluting biomass processor 1000 of FIG. 7D. These details have been previously discussed.

As used herein water reservoirs include but not limited to manmade reservoirs, ponds, lakes, and/or water retention facilities.

Regarding the product output 1050 from at least one of the non-polluting biomass processors 1000 disclosed above: in particular the product output as a form of activated carbon 1070 and/or carbon char 1072.

An experiment has been performed in the state of California using carbon char 1072 to remove water pollution from a lake of approximately 85 acres (about 35 hectares) with a depth of 30 feet (9.15 meters). At the start of the experiment, visibility into the water was limited to 2 inches (5 centimeters) due to algae plumes and plant growths. The lake was treated with approximately 6,000 pounds (2720 kilograms) of carbon char 1072. After about 6 weeks, the water visibility had improved to at least 8 feet (2.4 meters). Carbon char also removed the

[symbol]

Phosphorus (P) pollution was analyzed in two forms: First, non-soluble P in the lake water was estimated to have 27 milli-grams (mg) per liter, at the experiment's start. Carbon char 1072 absorbed about 99.9% of the non-soluble P, removing it from the lake water, at the experiment's end. Second, soluble P in the lake water was estimated to have 27 mg per liter, at the start. Carbon char 1072 absorbed about 99.8% of the non-soluble P, removing it from the lake water, at the end.

The lake water had a concentration of Phosphate (sometimes denoted as PO4-P) of about 284 mg per liter at the start. Carbon char 1072 removed about 86.6% of the Phosphate.

The lake water had a concentration of ammonia (sometimes denoted as N), of 1.1 mg per liter, at the start. Carbon char 1072 removed about 89.7% of the ammonia.

The lake water had a concentration of Nitrate (sometimes denoted as NO3-N) of about 52 mg per liter, at the start. Carbon char 1072 removed 64.3% of the nitrate.

Carbon char also removed turbidity and solids from the lake water. The turbidity was estimated as 68 NTU at the start. Carbon char 1072 removed about 99.9% of the turbidity by the end. Solids suspended in the lake water was estimated as 506 mg per liter. Carbon char 1072 removed about 80.2% of solids from the lake water by the end.

The volume of the lake is estimated as follows: There are 43,560 square feet in an acre. Assuming average depth of the lake is 30 feet, the volume of the lake is estimated as 43,560*30=1,306,800 cubic feet. There are 27 cubic feet in each cubic yard, so the volume of the lake is about 48,370 cubic yards. The 6,000 pounds divided by the 48,370 cubic yards is about 1 pound of carbon char 1072 per 8.1 cubic yards of polluted water. Put in metric units, 454 grams per 6.2 cubic meters or 1 kilogram carbon char 1072 per 2.2*6.2 m³=13.6 m³ of water.

A second experiment involved a golf course in California and its irrigation water needs. The golf course is about 80 acres (about 32.4 hectares). It usually requires about 270,000 cubic meters (m³) of water. Carbon char 1072 was applied once to a portion of the golf course, with the remainder of the golf course used as a control population. At the experiment's end, if the whole golf course had been covered, there would have been a 50% water savings, or roughly 135,000 m³ of water.

The total amount of carbon char 1072 required to cover the golf course is estimated as follows: The cost of the carbon char (at the time of the experiment) was $240,000 (US $). The estimated cost of purchasing the carbon char was $275 per cubic yard. Therefore, the estimated amount of carbon char to top dress the golf course is $240,000/($275/cubic yard), which is about 1,745.45 cubic yards or about 1334.5 cubic meters.

What is claimed is:

1. An apparatus, comprising:
A1) a non-polluting biomass processor 1000 adapted to respond to receipt of a biomass feedstock 1010 to generate at least two product outputs 1050 to at least partly address at least one local technical problem 1030, with said product outputs generated with non-polluting atmospheric emission 1042 and with non-polluting water emission 1044;
B1) wherein said biomass feedstock includes a version of a municipal waste biomass 1016; and
C1) said local technical problem 1030 includes a waste treatment problem 1036.

2. The apparatus of claim 1, wherein said product outputs include at least two of a carbon char 1072, a bio-oil 1060, an activated carbon 1070, a syngas 1080 and a form of pyrogas (1252 and/or 1522).

3. The apparatus of claim 2, wherein said syngas 1080 has a particulate density that insures non-polluting use of said syngas 1080.

4. The apparatus of claim 1, wherein said supply problem includes at least one of a local biomass waste composition 1710, a local biomass waste seasonal variation 1712, and a local biomass waste daily variation 1714.

5. The apparatus of claim 1, wherein said local technical problem includes a production problem further including at least one of a fuel for at least one vehicle 1700, electricity for at least one public facility 1702, a purification of water pollution 1704, and a purification of air pollution 1706.

6. The apparatus of claim 1, wherein said local technical problem includes a waste treatment problem further including at least one of a landfill problem 1720, a sewage sludge problem 1722, and an incineration problem 1724.

7. The apparatus of claim 1, wherein said biomass feedstock further includes a version of at least one of an industrial waste biomass, a landfill biomass and a sludge biomass.

8. The apparatus of claim 1, wherein said biomass feedstock is output from a biomass conveyor and/or is output from a biomass pre-processor.

9. The apparatus of claim 1, wherein said non-polluting biomass processor comprises
A9) a furnace 1100 adapted and/or configurable to operate at a first temperature 1110 in response to receiving a syngas 1080 to heat and generate a flue-gas at a second temperature;
B9) a thermal assembly adapted and/or configurable to separately receive said flue-gas at said second temperature, a biomass feedstock 1010, and a steam at a first temperature range to generate said flue-gas at a third temperature, a pyrogas, a carbon char 1072 and said steam at a second temperature range;
C9) an activated carbon reactor 1400 adapted and/or configurable to operate at or near said first temperature 1110 to receive said carbon char 1072 to generate said activated carbon 1070 and a second syngas 1442;
D9) a boiler 1300 adapted and/or configurable to receive said flue-gas to generate said steam at or near said first temperature 1110;
E9) an oil-gas separator adapted and/or configurable to receive said pyrogas to remove small particles to condense said raw biofuel oil and generate said third syngas 1080 without said small particles; and
F9) a dust separator 1500 adapted and/or configurable to receive said pyrogas 1082 to remove large particles from said pyrogas to generate said second pyrogas without said large particles.

10. The apparatus of claim 1, further comprising at least one of
A10) a biomass input pre-processor,
B10) a furnace 1100,
C10) an activated carbon reactor 1400,
D10) a thermal assembly,
E10) a boiler 1300,
F10) a condenser, [symbol]
H10) a dust separator 1500,
I10) each adapted and/or configurable to operate in said non-polluting biomass processor.

11. The apparatus of claim 10, further comprising at least one of
A11) said biomass input pre-processor adapted and/or configurable to respond to receiving at least one biomass composition to generate a biomass feedstock 1010 of specific particle size range and specific humidity range;
B11) said furnace 1100 adapted and/or configurable to operate at a first temperature 1110 in response to receiving a syngas 1080 to heat and generate a flue-gas at a second temperature;
C11) said thermal assembly adapted and/or configurable to separately receive said flue-gas at said second temperature, said biomass feedstock 1010, and a steam at a first temperature 1110 range to generate said flue-gas at a third temperature, a pyrogas, a carbon char 1072 and said steam at a second temperature range;
D11) said activated carbon reactor 1400 adapted and/or configurable to operate at or near said first temperature 1110 to receive said carbon char 1072 to generate an activated carbon 1070 and a second syngas 1080;
E11) said boiler 1300 adapted and/or configurable to receive said flue-gas to generate said steam at or near said first temperature 1110;
F11) said condenser adapted and/or configurable to receive said pyrogas to remove small particles to condense a raw biofuel oil and generate a third syngas 1080 without said small particles;
G11) said sludge separator adapted and/or configurable to receive said raw biofuel oil to generate at least one of a biofuel oil and/or bio-oil; and
H11) said dust separator 1500 adapted and/or configurable to receive said pyrogas 1082 to remove large particles from said pyrogas to generate a second pyrogas without said large particles.

12. The apparatus of claim 11, wherein said non-polluting biomass processor comprises
A12) said furnace 1100 adapted and/or configurable to operate at said first temperature 1110 in response to receiving said syngas 1080 to heat and generate said flue-gas at said second temperature;
B12) said thermal assembly adapted and/or configurable to separately receive said flue-gas at said second temperature, said biomass feedstock 1010, and said steam at said first temperature 1110 range to generate said flue-gas at said third temperature, said pyrogas, said carbon char 1072 and said steam at said second temperature range;
C12) said activated carbon reactor 1400 adapted and/or configurable to operate at or near said first temperature 1110 to receive said carbon char 1072 to generate said activated carbon 1070 and said second syngas 1080;
D12) said boiler 1300 adapted and/or configurable to receive said flue-gas to generate said steam at or near said first temperature 1110;
E12) said condenser adapted and/or configurable to receive said pyrogas to remove small particles to condense said raw biofuel oil and generate said third syngas 1080 without said small particles;
F12) said sludge separator adapted and/or configurable to receive said raw biofuel oil to generate said biofuel oil and/or said bio-oil; and
G12) said dust separator 1500 adapted and/or configurable to receive said pyrogas 1082 to remove large particles from said pyrogas to generate said second pyrogas without said large particles.

13. The apparatus of claim 1, wherein said non-polluting atmospheric emission includes essentially no form of dioxin or ash.

14. The apparatus of claim 1, wherein at least one of said product output 1050 is a form of at least one of activated carbon 1070 and carbon char 1072;
A14) wherein when a sufficient amount of said product output is put into a water reservoir, which is suffering pollution, the water reservoir will be at least N percent free of said pollution with M days;
B14) wherein said N is not less than a member of the group consisting of 80, 90, 95, 96, 97, 98, 99, 99.5;
C14) wherein said M is not more than a member of the group consisting of 7, 14, 21, 28, and 60; and
D14) wherein said sufficient amount is not more one pound per W cubic yards, where W is a member of the group consisting of 4, 6, 8, 10, 12 and 14.

15. The apparatus of claim 1, wherein at least one said product output 1050 is a form of at least one of activated carbon 1070 and carbon char 1072;
A15) wherein when a sufficient amount of said product output is put onto the top T centimeters of an acre of agricultural land, said agricultural land requires K per cent as much water to grow a crop as before;
B15) wherein said T is not more than a member of the group consisting of 0[period]5, 1, 1[period]5, 2, 2[period]5, 5, 7[period]5, 10, 12[period]5, and 15;
C15) wherein said K is not more than a member of the group consisting of 20, 40, 50, 60, and 80; and
D15) wherein said crop is a member of at least one of the following: a grass, a tree, a vegetable, and a vine.
